(19) United States
(12) Patent Application Publication
(10) Pub. No.: US 2022/0376970 A1
(43) Pub. Date: Nov. 24, 2022

(54) METHODS AND SYSTEMS FOR TROUBLESHOOTING DATA CENTER NETWORKS

(71) Applicant: VMware, Inc., Palo Alto, CA (US)

(72) Inventors: Rahul Chawathe, Karnataka (IN); Gyan Sinha, Maharashtra (IN); Amarjit Gupta, Maharashtra (IN)

(73) Assignee: VMware, Inc., Palo Alto, CA (US)

(21) Appl. No.: 17/325,077

(22) Filed: May 19, 2021

(51) Int. Cl. H04L 12/24; H04L 12/26

(52) U.S. Cl. CPC H04L 41/0654; H04L 43/0823

(57) ABSTRACT

Computational methods and systems troubleshoot problems in a data center network. A dependency graph is constructed in response to an entity of the network exhibiting anomalous behavior. The dependency graph comprises nodes that correspond to metrics of entities that transmit data to and receive data from the entity over the network and edges that represent a connection between metrics. An anomaly score is determined for each metric of the dependency graph. Correlated metrics connected by the edges of the dependency graph are determined. Time-change events of the metrics of the dependency graph are also identified. Each metric of the dependency graph is rank ordered based on the anomaly scores, correlations with other metrics, and the time-change events. Higher ranked metrics are more likely associated with a problem in the network that corresponds to the anomalous behavior of the entity.

### TECHNICAL FIELD

This disclosure is directed to methods and systems that troubleshoot problems in data center networks.

### BACKGROUND

Electronic computing has evolved from primitive, vacuum-tube-based computer systems, initially developed during the 1940s. to modern electronic computing systems in which large numbers of multi-processor computer systems. such as server computers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems include data centers and are made possible by advances in computer networking, distributed operating systems and applications, data-storage appliances, computer hardware, and software technologies. The number and size of data centers have continued to grow to meet the increasing demand for information technology (⁻IV) services, such as running applications for organizations that provide business services. web services, and other cloud services to millions of customers each day.

Virtualization has made a major contribution to moving an increasing number of cloud services to data centers by enabling creation of software-based, or virtual, representations of server computers, data-storage devices, and networks. For example, a virtual computer system, also known as a virtual machine (“VM”), is a self-contained application and operating system implemented in software. Unlike applications that run on a physical computer system. a VM may be created or destroyed on demand, may be migrated from one physical server computer to another in a data center, and based on an increased demand for services provided by an application executed in a VM, may be cloned to create multiple VMs that run on one or more physical server computers. Network virtualization has enabled creation, provisioning, and management of virtual networks implemented in software as logical networking devices and services. such as logical ports, logical switches, logical routers, logical firewalls, logical load balancers, virtual private networks (“VPNs”) and more to connect workloads. Network virtualization allows applications and VMs to run on a virtual network as if the applications and VMs were running on a physical network and has enabled the creation of software-defined data centers within a physical data center. As a result, many organizations no longer have to make expensive investments in building and maintaining physical computing infrastructures. Virtualization has proven to be an efficient way of reducing IT expenses for many organizations while increasing computational efficiency, access to cloud services, and agility for all size businesses, organizations, and customers.

In recent years. data-center networks have become more complex with advancements in virtual networking technologies. Although these networking technologies provide many advantages for planning and deployment of applications within a data center, troubleshooting these virtual networks has become increasingly more complicated. To compound this problem, large IT organizations have multiple silos managing various parts or a network, which causes logistical and visibility constraints during troubleshooting. In the event of a problem with executing an application in a data center, the network is typically the suspected source of the problem. Network administrators have a challenging task of troubleshooting the problem, and if the network is determined to be the source of the problem, network administrators have an additional challenging task of identifying the root cause of the problem. As a result, troubleshooting a network problem can takes hours and in some cases days to complete. Organizations that run their applications in data centers cannot afford network problems that delay or slow performance of their applications. Performance issues frustrate users, damage a brand name, result in lost revenue, and deny people access to vital services. Network management tools have been developed to monitor physical and virtual network performance. However, network management tools that provide fast end-to-end troubleshooting of physical and virtual network problems of a data center do not currently exist. Data center administrators seek network management tools that provide rapid troubleshooting of physical and virtual network problems and can identify likely root causes of the problems.

### SUMMARY

Computational methods and systems described herein are directed to troubleshooting problems in a data center network. A dependency graph is constructed in response to an entity of the network exhibiting anomalous behavior. The dependency graph comprises nodes and edges. The nodes represent metrics of entities that transmit data to and receive data from the entity over the network. Nodes also represent network resources, data storage, and compute resources consumed by the entity. Edges represent a connection between metrics. Methods and systems determine an anomaly score for each metric of the dependency graph, determine correlated metrics connected by the edges of the dependency graph, and determine time-change events of the metrics of the dependency graph. Each metric of the dependency graph is rank ordered based on the anomaly scores, correlations with other metrics, and the time-change events. Higher ranked metrics are more likely associated with a problem in the network that corresponds to the anomalous behavior of the entity. The highest ranked metrics associated with a root cause of the problem in the network are displayed in a graphical user interface. Methods include determining remedial measures for the highest ranked metrics and displaying the remedial measures in the graphical user interface, thereby enabling a user to select a remedial measure that corrects the problem.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine “VM”) and VM execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing the containers on a VM.

FIG. 13 shows generalized hardware and software components that form virtual networks from a general-purpose physical network.

FIGS. 14A-14B show a physical layer of a data center and a virtual layer.

FIG. 15 shows a plot of an example metric.

FIG. 16 shows objects of an example data center.

FIG. 17 shows an example key performance indicator (“KPI”).

FIG. 18 shows an example KPI recorded in a time interval.

FIG. 19 shows an example graphical user interface (“GUI”).

FIG. 20 shows an example of entities that send data to and receive data from a starting entity.

FIGS. 21A-21B show different portions of an example dependency graph.

FIGS. 22A-22B show example plots of metrics associated with an entity of a dependency graph.

FIGS. 23A-23C show a median absolute deviation for an example set of metric values.

FIG. 24A shows plots of three example unsynchronized metrics.

FIG. 24B shows a plot of metric values synchronized to a general set of uniformly spaced time stamps.

FIG. 24C shows plots of three example unsynchronized metrics.

FIG. 25 shows example probability distributions of a metric.

FIGS. 26A-26C show an example of anomaly scores, correlations, and change events calculated for metrics of entities in an example dependency graph.

FIG. 27A shows an example GUI that displays example entities in an entity graph.

FIG. 27B shows an example GUI that displays examples of anomalous metrics corresponding ranks, and recommendations for addressing the associated problems.

FIG. 28 is a flow diagram of a method for troubleshooting a data center network.

FIG. 29 is a flow diagram illustrating an example implementation of the “check KPIs for anomalous behavior in a time interval” procedure performed in FIG. 28.

FIG. 30 is a flow diagram illustrating an example implementation of the “construct a dependency graph for entities of the network” procedure performed in FIG. 28.

FIG. 31 is a flow diagram illustrating an example implementation of the “determine an anomaly score for each metric of the dependency graph” procedure performed in FIG. 28.

FIG. 32 is a flow diagram illustrating an example implementation of the “determine correlated metrics connected by edges of the dependency graph” procedure performed in FIG. 28.

FIG. 33 is a flow diagram illustrating an example implementation of the “determine time-change events of the correlated metrics of the dependency graph” procedure performed in FIG. 28.

### DETAILED DESCRIPTION

This disclosure presents computational methods and systems for troubleshooting problems in a data center networks. In a first subsection, computer hardware, complex computational systems, and virtualization are described. Network virtualization is described in a second subsection. Methods and systems for troubleshooting network problems and ranking causes of network problems are described below in a third subsection.

Computer Hardware, Complex Computational Systems, and Virtualization

The term “abstraction” does not mean or suggest an abstract idea or concept. Computational abstractions are tangible, physical interfaces that are implemented using physical computer hardware, data-storage devices, and communications systems. Instead, the term “abstraction” refers. in the current discussion, to a logical level of functionality encapsulated within one or more concrete, tangible. physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. Software is a sequence of encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices. Multi-cloud aggregations, cloud-computing services, virtual-machine containers and virtual machines, containers, communications interfaces, and many of the other topics discussed below are tangible, physical components of physical, electro-optical-mechanical computer systems.

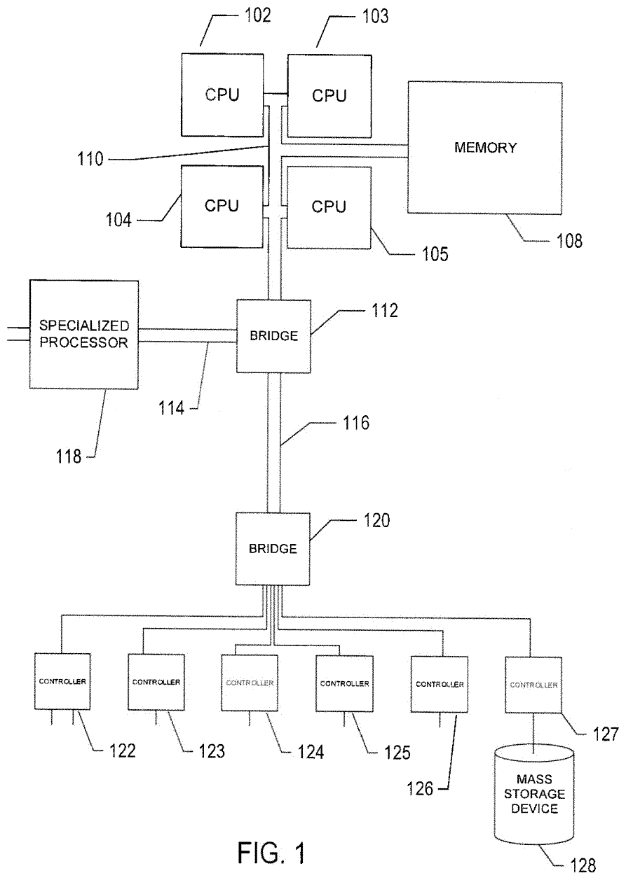

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories. and other physical data-storage devices. Those familiar with modern science and technology appreciate that electromagnetic radiation and propagating signals do not store data for subsequent retrieval. and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

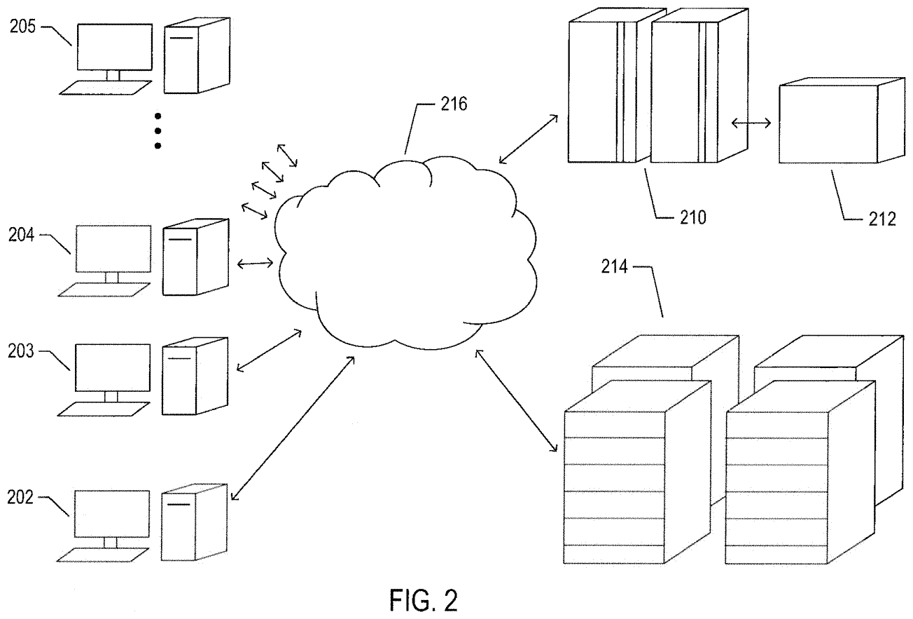

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured. managed, and maintained by service-provider organizations. For example, an e-commerce retailer generally purchased, configured, managed, and maintained a data center including numerous web server computers, back-end computer systems, and data-storage systems for serving web pages to remote customers. receiving orders through the web-page interface, processing the orders, tracking completed orders, and other myriad different tasks associated with an e-commerce enterprise.

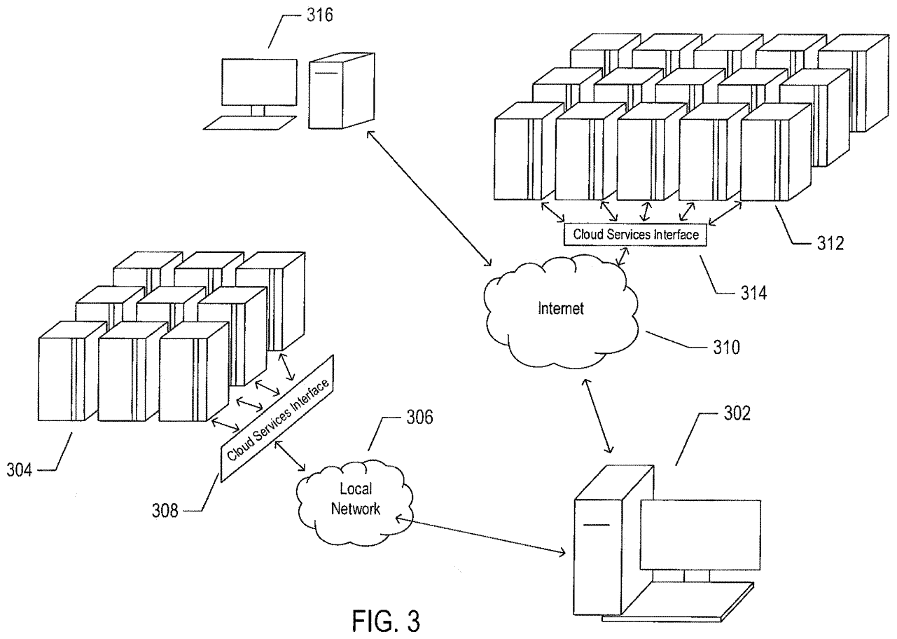

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312. configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase. manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

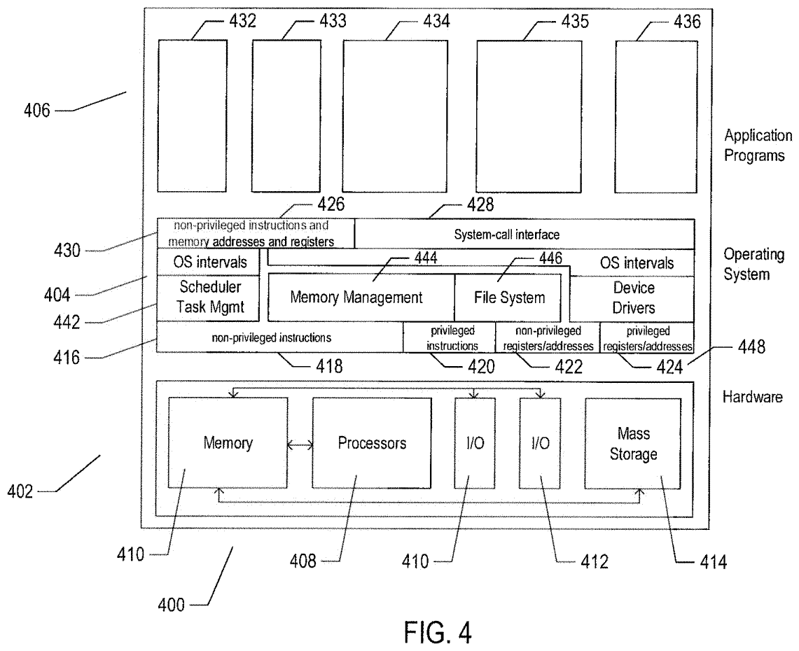

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, different types of input-output (“I/O”) devices 410 and 412, and mass-storage devices 414. Of course, the hardware level also includes many other components, including power supplies, internal communications links and busses, specialized integrated circuits. many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420. a set of non-privileged registers and memory addresses 4, and a set of privileged registers and memory addresses 424. In general. the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone. accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442. memory management 444, a the system 446, device drivers 448. and many other components and modules. To a certain degree, modern operating systems provide numerous levels of abstraction above the hardware level, including virtual memory, which provides to each application program and other computational entities a separate, large. linear memory-address space that is mapped by the operating system to various electronic memories and mass-storage devices. The scheduler orchestrates interleaved execution of different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks. mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems. the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

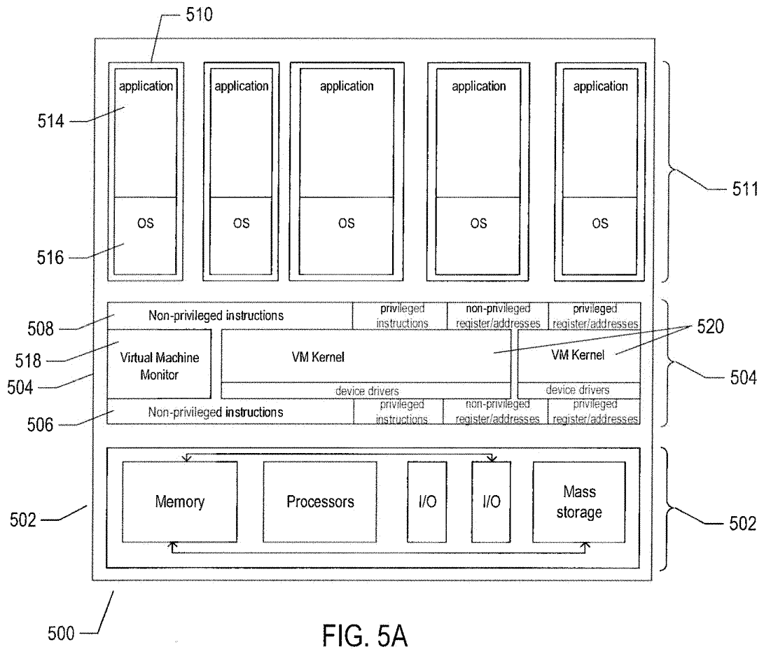

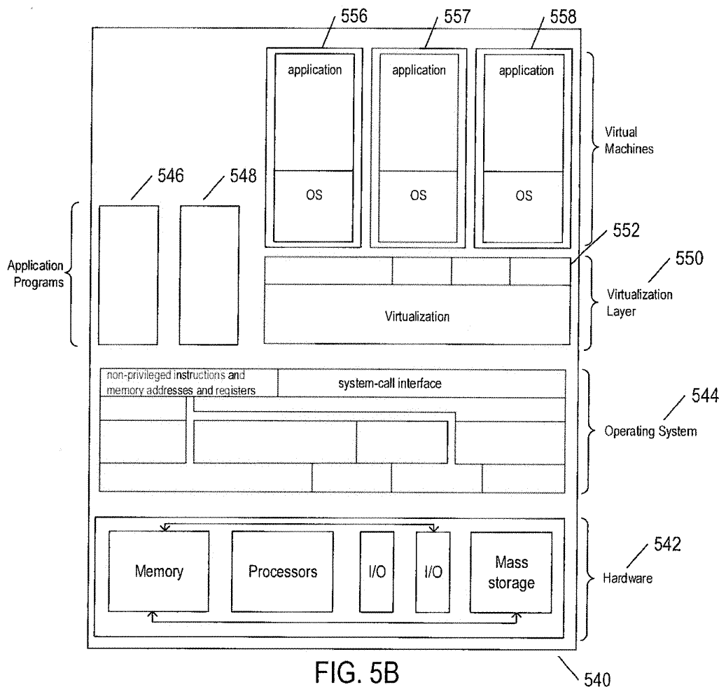

For the above reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtual layer 504 that interfaces through a virtualization-layer!hardware-layer interface 506, equivalent to interface 416 in FIG. 4, to the hardware. The virtual layer 504 provides a hardware-like interface to many VMs, such as VM 510, in a virtual-machine layer 511 executing above the virtual layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtual layer interface 504 rather than to the actual hardware interface 506. The virtual layer 504 partitions hardware devices into abstract virtual-hardware layers to which each guest operating system within a VM interfaces. The guest operating systems within the VMs, in general. are unaware of the virtual layer and operate as if they were directly accessing a true hardware interface. The virtual layer 504 ensures that each of the VMs currently executing within the virtual environment receive a fair allocation of underlying hardware devices and that all VMs receive sufficient devices to progress in execution. The virtual layer 504 may differ for different guest operating systems. For example. the virtual layer is generally able to provide virtual hardware interfaces for a variety of different types of computer hardware. This allows. as one example, a VM that includes a guest operating system designed for a particular computer architecture to run on hardware of a different architecture. The number of VMs need not he equal to the number of physical processors or even a multiple of the number of processors.

The virtual layer 504 includes a virtual-machine-monitor module 518 “VMM”), also called a “hypervisor,” that virtualizes physical processors in the hardware layer to create virtual processors on which each of the VMs executes. For execution efficiency, the virtual layer attempts to allow VMs to directly execute non-privileged instructions and to directly access non-privileged registers and memory. However, when the guest operating system within a VM accesses virtual privileged instructions, virtual privileged registers, and virtual privileged memory through the virtual layer 504, the accesses result in execution of virtualization-layer code to simulate or emulate the privileged devices. The virtual layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtual layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtual layer 550 is also provided, in computer 540, but, unlike the virtual layer 504 discussed with reference to FIG. 5A, virtual layer 550 is layered above the operating system 544. referred to as the “host OS,” and uses the operating system interface to access operating-system-provided functionality as well as the hardware. The virtual layer 550 comprises primarily a VMM and a hardware-like interface 552, similar to hardware-like interface 508 in FIG. 5A. The hardware-layer interface 552. equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtual layer 550 may reside within the host-operating-system kernel, such as a specialized driver incorporated into the host operating system to facilitate hardware access by the virtual layer.

It should be noted that virtual hardware layers, virtual layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtual layers, and guest operating systems are abstract or intangible. Virtual hardware layers, virtual layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

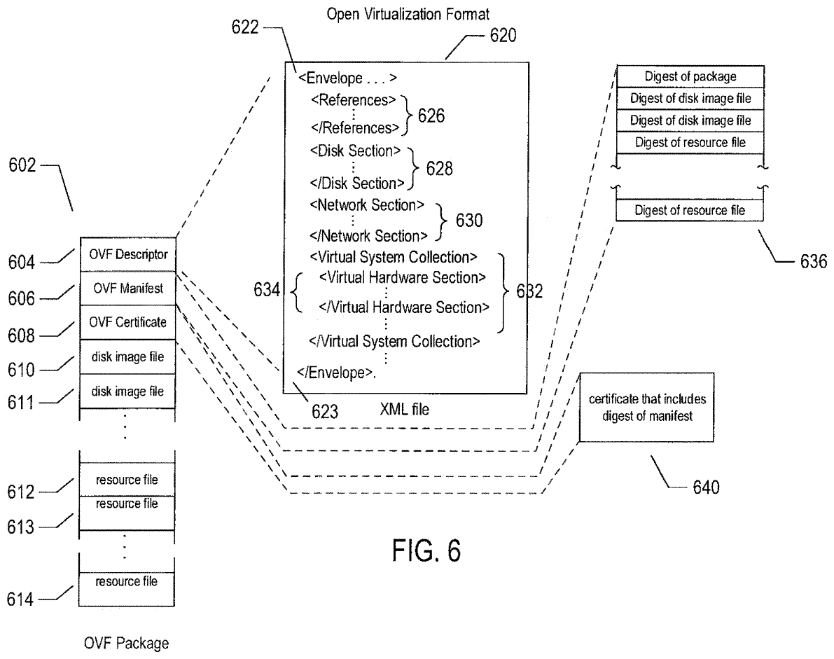

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all Files that are part of the OVF package, a disk section 628 that contains meta information about all of the virtual disks included in the OVF package, a network section 630 that includes meta information about all of the logical networks included in the OVF package. and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a soft: are service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtual layers running on many different types of computer hardware. A next level of abstraction, referred to as virtual data centers or virtual infrastructure, provide a data-center interface to virtual data centers computationally constructed within physical data centers.

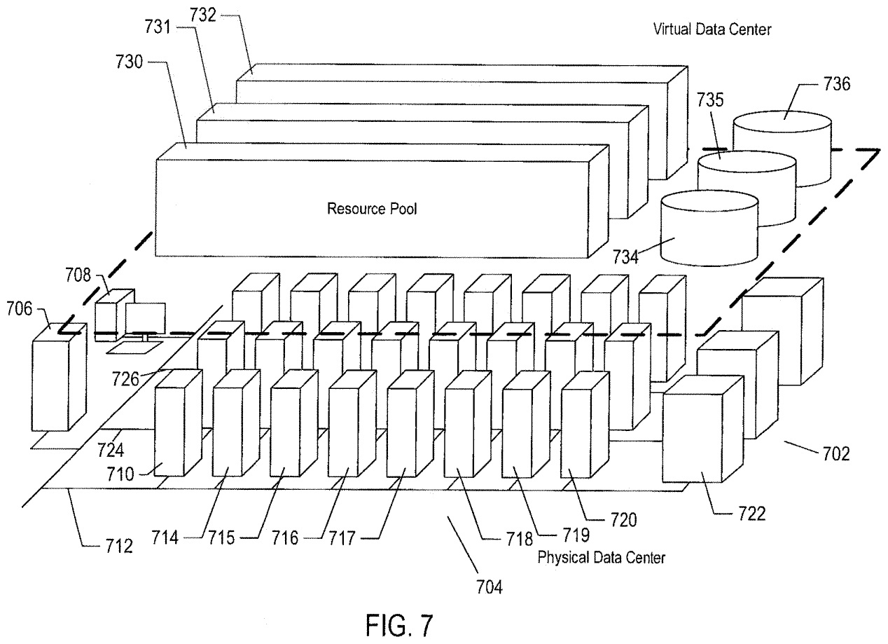

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-?20 and a mass-storage array 722. The physical data center shown in FIG. 7 includes three local area networks 712, 724, and 726 that each directly interconnects a bank of eight server computers and a mass-storage array. The individual server computers. such as server computer 710, each includes a virtual layer and runs multiple VMs. Different physical data centers may include many different types of computers. networks, data-storage systems and devices connected according to many different types of connection topologies. The virtual-interface plane 704, a logical abstraction layer shown by a plane in FIG. 7, abstracts the physical data center to a virtual data center comprising one or more device pools. such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore. the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching. and maintenance of VMs and virtual appliances as well as to provide high-level, distributed functionalities that involve pooling the devices of individual server computers and migrating VMs among server computers to achieve load balancing, fault tolerance, and high availability.

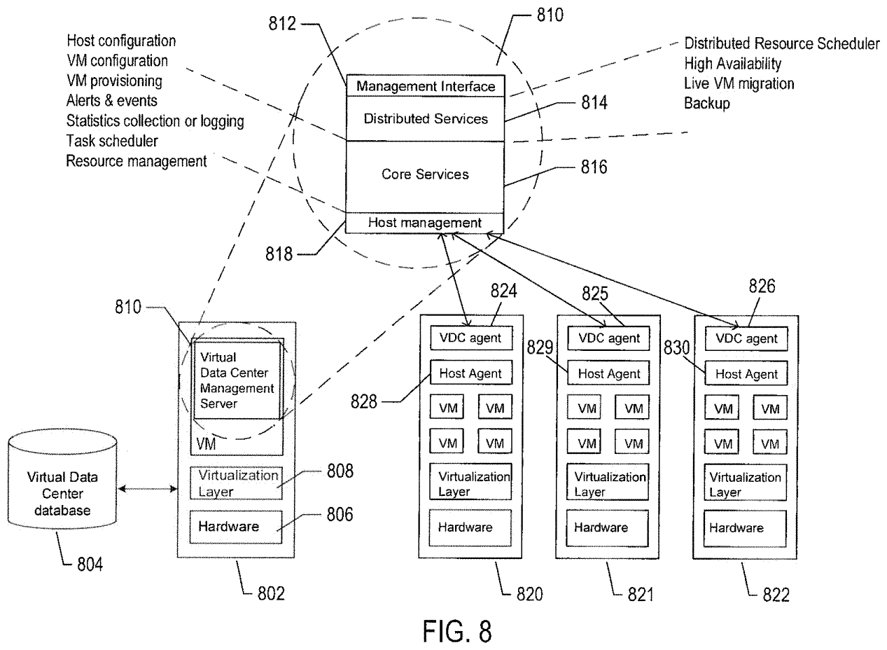

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtual layer 808, and runs a virtual-data-center management-server VM 810 above the virtual layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812. distributed services 814, core services 816. and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer. and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtual layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents. monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization. both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

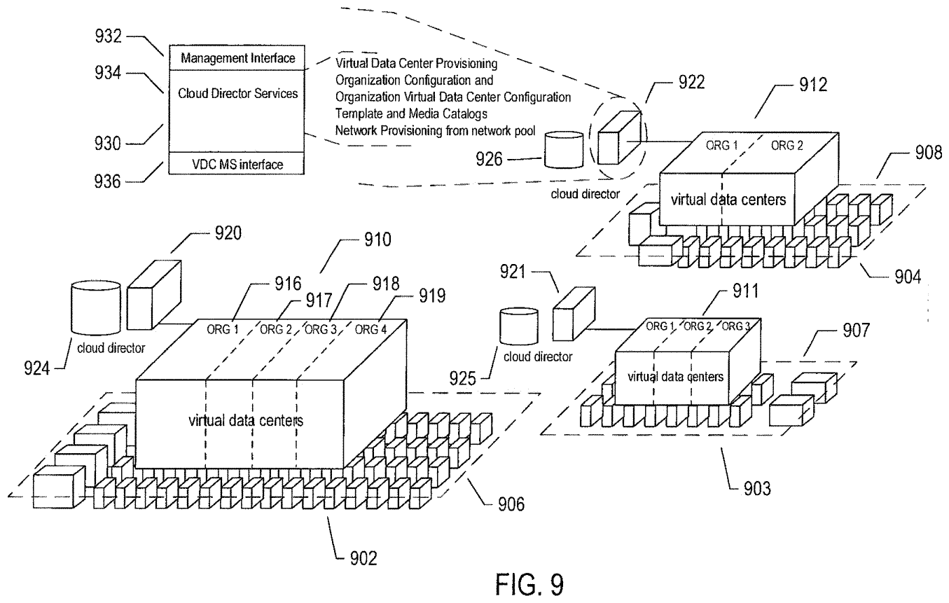

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However. this level of abstraction does not fully facilitate aggregation of single-tenant and multi-tenant virtual data centers into heterogeneous or homogeneous aggregations of cloud-computing facilities.

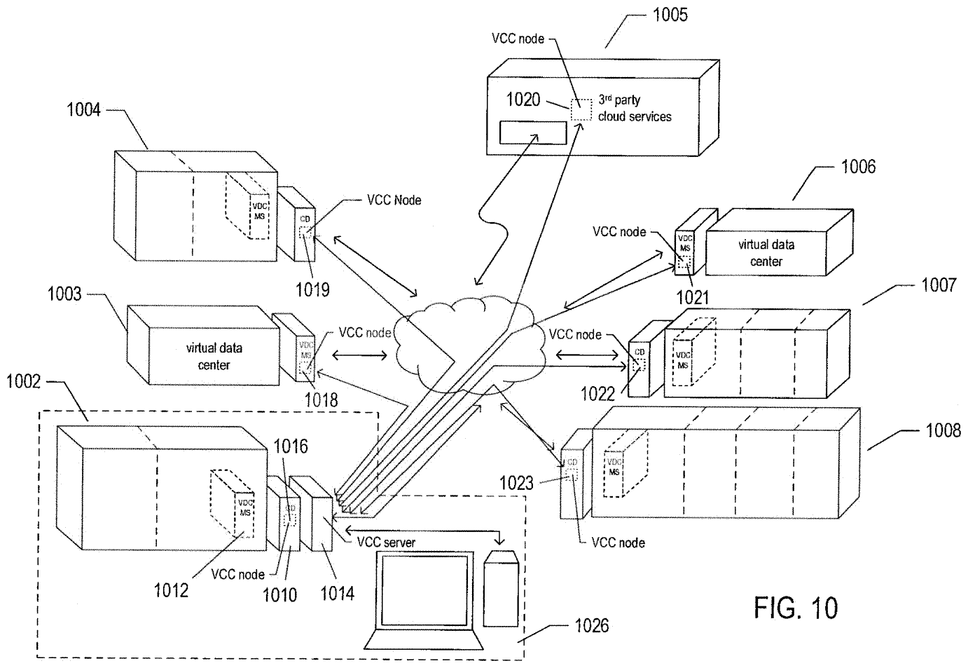

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014. acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtual layers, described in the previous subsection, have received widespread adoption and use in a variety of different environments. from personal computers to enormous distributed computing systems, traditional virtualization technologies are associated with computational overheads. While these computational overheads have steadily decreased, over the years. and often represent ten percent or less of the total computational bandwidth consumed by an application running above a guest operating system in a virtualized environment, traditional virtualization technologies nonetheless involve computational costs in return for the power and flexibility that they provide.

While a traditional virtual layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files not included the container's namespace and cannot interact with applications running in other containers. As a result. a container can be booted up much faster than a VM, because the container uses operating-system-kernel features that are already available and functioning within the host. Furthermore, the containers share computational bandwidth, memory, network bandwidth, and other computational resources provided by the operating system. without the overhead associated with computational resources allocated to VMs and virtual layers. Again, however, OSL virtualization does not provide many desirable features traditional virtualization. As mentioned above, OSL virtualization does not provide a way to run different types of operating systems for different groups of containers within the same host and OSL-virtualization does not provide for live migration of containers between hosts, high-availability functionality. distributed resource scheduling, and other computational functionality provided by traditional virtualization technologies.

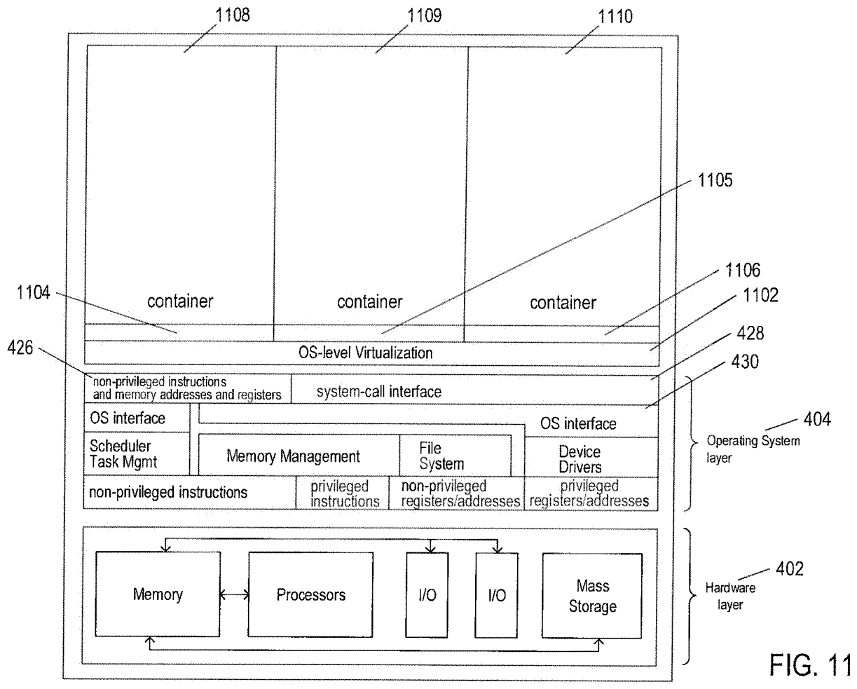

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404. OSL virtualization involves an OSL virtual layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

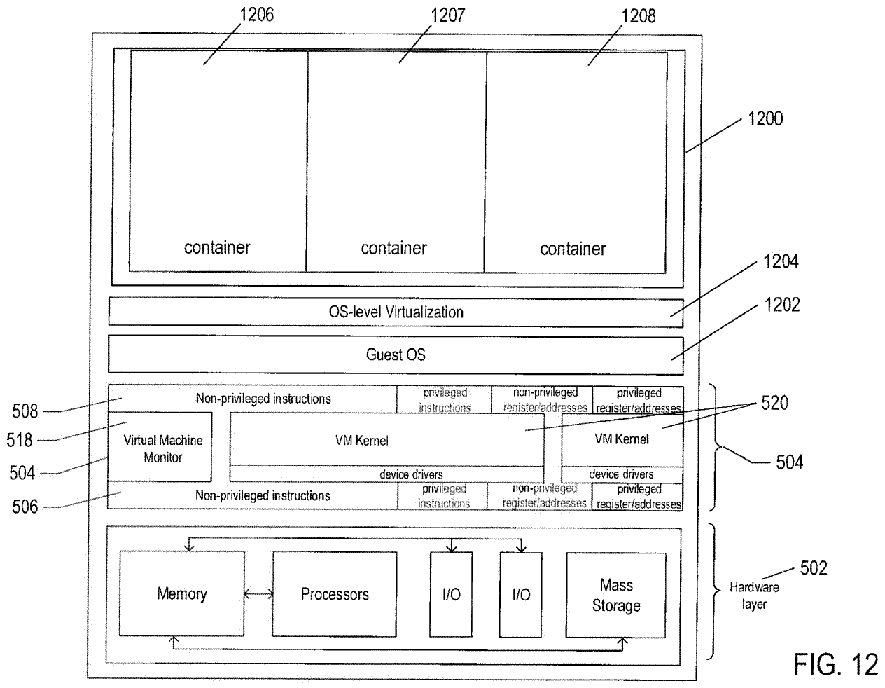

FIG. 12 shows an approach to implementing the containers on a VM. FIG. 12 shows a host computer similar to that shown in FIG. 5A, discussed above. The host computer includes a hardware layer 502 and a virtual layer 504 that provides a virtual hardware interface 508 to a guest operating system 1102. Unlike in FIG. 5A, the guest operating system interfaces to an OSL-virtual layer 1104 that provides container execution environments 1206-1208 to multiple application programs.

Note that, although only a single guest operating system and OSL virtual layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtual layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted to provide additional execution environments and associated resources for additional application instances. The resources available to the guest operating system are efficiently partitioned among the containers provided by the OSL-virtual layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling. and other such features. Containers provide share-based allocation of computational resources to groups of applications with guaranteed isolation of applications in one container from applications in the remaining containers executing above a guest operating system. Moreover, resource allocation can be modified at run time between containers. The traditional virtual layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12. provides many of the advantages of both a traditional virtual layer and the advantages of OSL virtualization.

### Network Virtualization

A physical network comprises physical switches, routers, cables, and other physical devices that transmit data within a data center. A logical network is a virtual representation of how physical networking devices appear to a user and represents how information in the network flows between objects connected to the network. The term “logical” refers to an IP addressing scheme for sending packets between objects connected over a physical network. The term “physical” refers to how actual physical devices are connected to form the physical network. Network virtualization decouples network services from the underlying hardware, replicates networking components and functions in software, and replicates a physical network in software. A virtual network is a software-defined approach that presents logical network services, such as logical switching, logical routing, logical firewalls, logical load balancing, and logical private networks to connected workloads. The network and security services are created in software that uses IP packet forwarding from the underlying physical network. The workloads are connected via a logical network, implemented by an overlay network, which allows for virtual networks to be created in software. Virtualization principles are applied to a physical network infrastructure to create a flexible pool of transport capacity that can be allocated. used, and repurposed on demand.

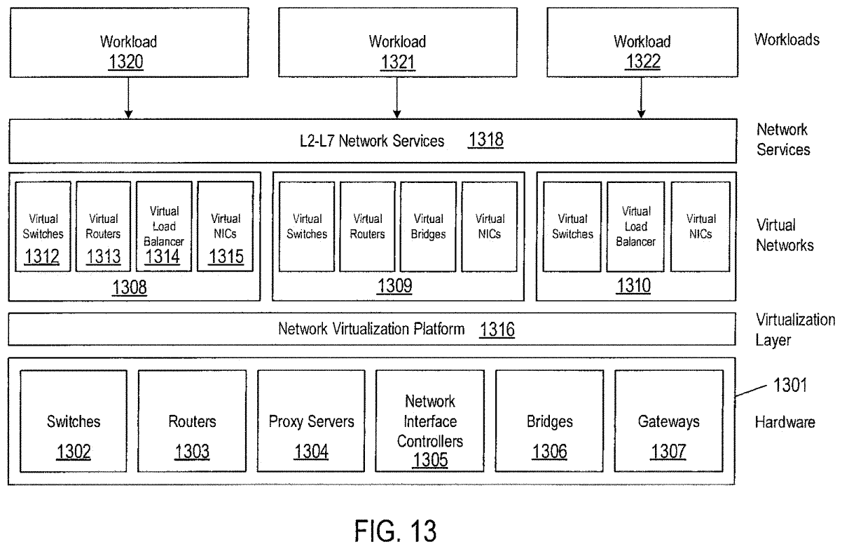

FIG. 13 shows generalized hardware and software components that form virtual networks from a general-purpose physical network. The physical network is a hardware layer 1301 that include switches 1302, routers 1303, proxy servers 1304, network interface controllers 1305, bridges 1306, and gateways 1307. Of course, the physical network may also include many other components not shown, such as power supplies, internal communications links and busses, specialized integrated circuits, optical devices, and many other components. In the example of FIG. 13. software components form three separate virtual networks 1308-1310 are shown. Each virtual network includes virtual network devices that execute logical compute services. For example, virtual network 1308 includes virtual switches 1312, virtual routers 1313, virtual load balancer 1314. and virtual network interface cards (“vNICs”) 1315 that provide logical switching, logical routing. logical firewall, and logical load balancing services. The virtual networks 1308-1310 interface with components of the hardware layer 1301 through a network virtualization platform 1316 that provisions physical network services, such as L2-L7 network systems interconnection (“OSI”) services, to the virtual networks 1308-1310, creating L2-L7 network services 1318 for connected workloads. For example, the virtual switches, such as virtual switches 1312, may provide L2, L3. access control list (“ACU”), and firewall services. In FIG. 13, the virtual networks 1308-1310 provide L2-L7 network services 1318 to connected workloads 1320-1322. VMs. containers, and multi-tier applications generate the workloads 1320-1322 that are sent using the L2-L7 network services 1318 provided by the virtual networks 1308-1310.

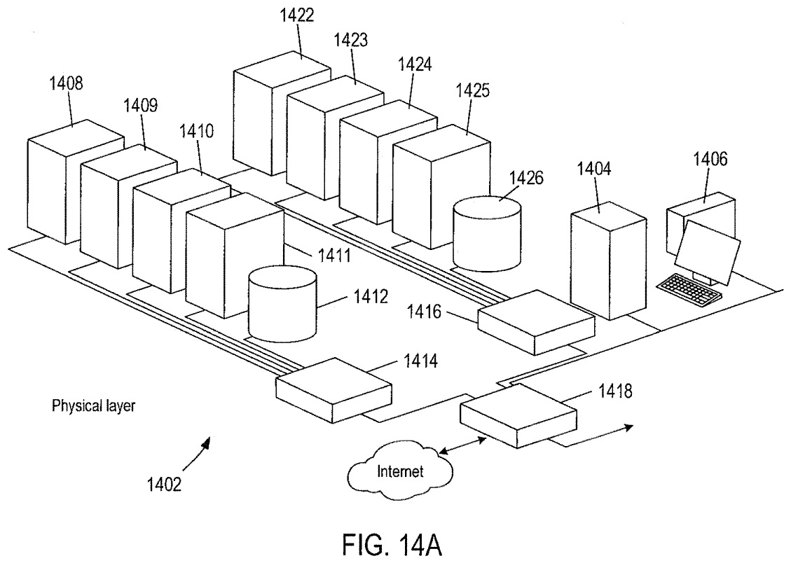

FIGS. 14A-14B show a physical layer of a data center and a virtual layer, respectively. In FIG. 14A, a physical data center 1402 comprises a management server computer 1404 and any of various computers, such as PC 1406. on which a virtual-data-center management interface may be displayed to system administrators and other users. The physical data center 1402 additionally includes hosts or server computers. such as server computers 1408-1411, mass-storage devices, such as a mass-storage device 1412, switches 1414 and 1416, and a router 1418 that connects the server computers and mass-storage devices to the Internet, the virtual-data-center management server 1404, the PC 1406. and other server computers and mass-storage arrays (not shown). In the example of FIG. 14A, each of the switches 1414 and 1416 interconnects four server computers and a mass-storage device to each other and connects the server computers and the mass-storage devices to the router 1418. For example, the switch 1414 interconnects the four server computers 1408-1411 and the mass-storage device 1412 to a router 1418 that is in turn connected to the switch 1416, which interconnects four server computers 1422-1425 and a mass-storage device 1426. The example physical data center 1402 is provided as an example of a data center. Physical data centers may include a multitude of server computers. networks, data-storage systems and devices connected according to many different types of connection topologies.

In FIG. 14B. a virtual layer 1428 is separated from the physical data center 1402 by a virtual-interface plane 1430. The virtual layer 1428 includes virtual objects, such as VMs and virtual components of three example virtual networks 1432-1434, hosted by the server computers of the physical data center 1402. Each virtual network has a network edge that is executed in a VM and serves as a platform for maintaining the corresponding virtual network services, such as a corresponding firewall, switch, and load balancing. The virtual networks and corresponding VMs may be owned by different organizations. For example, the VMs on virtual network 1432 may provide database services for one data center tenant, the VMs on virtual network 1433 may provide web services for a second data center tenant, and the VMs on virtual network 1434 may provide financial services for a third data center tenant. Each virtual network includes a virtual switch that interconnects VMs of an organization to a virtual storage and to a virtual router 1436. For example, virtual network 1433 comprises VMs 1438-1441 and virtual storage 1442 interconnected by a virtual switch 1444 that is connected to the virtual router 1436. In the example of FIG. 14B, firewalls 1448-1450 provide network security by controlling incoming and outgoing network traffic to the virtual networks 1433-1435 based on predetermined security rules. Each of the firewalls 1448-1450 is maintained by a corresponding network. In this example, the network edge of the virtual network 1434 executes a load balancer 1452 that evenly distributes workloads to the VMs connected to the virtual network. The virtual layer 1428 is provided as an example virtual layer. Different virtual layers include many different types of virtual switches, virtual routers, virtual ports, and other virtual devices connected according to many different types of network topologies. FIG. 14B also shows a network management server 1454 that is hosted by the management computer server 1404. maintains network policies, and executes the methods described below.

Functionality of a data center network is characterized in terms of network traffic and network capacity. Network traffic is the amount data moving through a network at any point in time and is typically measured as a data rate, such as bits, bytes or packets transmitted per unit time. Throughput of a network channel is the rate at which data is communicated from a channel input to a channel output. Capacity of a network channel is the maximum possible rate at which data can be communicated from a channel input to a channel output. Capacity of a network is the maximum possible rate at which data can be communicated from channel inputs to channel outputs of the network. The availability and performance of distributed applications executing in a data center largely depends on the data center network successfully passing data over data center virtual networks.

Data center network problems typically occur when there is (1) a reduction in capacity of a physical or virtual network or (2) network traffic increases such that the network becomes congested. Examples of problems that reduce network capacity include (1) a port of a logical port bundle fails. thereby reducing the capacity of the corresponding network channel; (2) a port on a switch or router fails, thereby reducing the capacity of the switch or router; and (3) a firewall rule is misconfigured, causing packets that should pass through the firewall to be dropped. Examples of problems that increases network traffic include (1) a new application is deployed in a network. which increases the amount of data on the network at any point in time; (2) the load on a webserver increases for a period of time (e.g., seasonal sale on an online shopping portal): (3) a loop in the network is misconfigured to replicate packets on the network; and (4) multiple traffic streams temporarily generate traffic on a network channel that is beyond the channel's capacity (e.g. backup task firing periodically).

The problems described above are root causes of decreases in network capacity and/or increases in network traffic that deteriorate application performance. However, these root causes may in turn have been caused by higher-level root causes associated hardware failures and software failures elsewhere within a data center. Hardware failures include failures of physical switches, routers, ports, and optics of the network. Software failures include network configuration errors, network design errors or limitations, and application coding errors. An example of a network configuration error is an error in configuring a virtual network. An example of a network design error is a virtual network configured to handle traffic that exceeds the provisioned capacity of a physical network used by the virtual network. An example of an application coding error is a coding error that causes an application to inject more traffic into a virtual network than the application would without the coding error.

Organizations that run applications in data centers cannot afford network problems that delay or slow performance of their applications. Application performance problems frustrate users, damage a brand name. result in lost revenue, and in many cases deny people access to vital services. Most applications are resilient to a certain amount of network traffic delays andlor data losses. But applications have thresholds. If functionality of a data center network deteriorates, traffic delays and data losses exceed these thresholds and application performance deteriorates or fails completely, which is unacceptable to application owners and application users. For example, consider a website application executing in a data center. The application depends on communicating with other applications over a virtual network of the data center. When the data center network becomes congested. traffic on the virtual network is slowed and the website application response time increases or packet drops become so frequent the website application is non-responsive and fails to complete tasks. Such problems can damage the brand name associated with the website and the application owner. Network management tools have been developed to collect and monitor server computer and VM metrics and physical and virtual network metrics. However, troubleshooting a network problem with typical network management tools is time consuming and can take hours and in some cases days to complete.

### Methods and Systems for Troubleshooting Network Problems and Ranking Root Causes of Network Problems

Methods and systems described herein perform network troubleshooting to determine a root cause of a network problem or prove that the network is not the root cause. In a case where the network itself is the problem, methods and systems rank order potential root cause of a network problem and identify objects in the network affected by the problem. Methods are executed as machine readable instructions in a network management server, such as example network management server 1454 of FIG. 14B, that is executed on a host computer system in the physical data center. For example, methods described below may be integrated with vRealize® Network Insight™ (“vRNI”) owned by VMware Inc. The network management server collects metrics from objects executing in a data center and from physical and virtual network objects. The metrics are sent from data center objects to the network management server, which executes the methods of troubleshooting and root cause detection in the management server computer as described below. Methods of the network management server significantly reduces a network administrator's mean time to resolution of a network problem from hours and/or days to only a few minutes or seconds. Rapid identification of a highest-level root cause of a problem in a data center network enables rapid deployment of remedial measures to restore the network. For example, in response to a determination that a change in a network configuration caused a network failure, the network configuration may be rolled back to the configuration of the network prior to the change to allow administrators an opportunity to correct the problem in the new configuration. Remedial measures include restating network devices, such as switches and routers, migrating VMs, reinstalling a network configuration, and restarting a host server computer.

In the following discussion, an “entity” is as an object of interest connected to a network. Entities include VMs, a virtual port, such as a virtual network interface card (“vNIC”), a physical port, and a switch. Methods and systems fetch network details from network configuration managers and model various objects as entities and periodically fetch various performance metrics, such as CPU usage of each VM, memory usage of each VM, packet rates, packet drops on ports. and latency metrics. For example, VMware's vRNI provides search capabilities using natural language processing (“NLP”) to search for relevant entities and display their metrics in the network.

Because a problem observed at one entity in a data center network may be correlated with one or problems at other entities that use the same network, methods and systems troubleshoot a problem with an assumption that the problem is likely correlated with one or more problems at other entities connected to the same virtual or physical network. In a given time interval. a problem detected at an entity or between two entities correlates with one of the following in the time interval: First, at least one of the metrics associated with the entity displays anomalous behavior. Second, metrics of one or more other entities in the network show anomalous behavior. Third. metrics of the entity correlates with one or more metrics of the other entities in the network.

Methods and systems begin by inspecting key performance indicators (“KPIs”) for network problems in a data center. The KPIs are streams of time-dependent metric data generated by operating systems or metric monitoring agents of various entities that transmit data over a data center network. In general, a stream of metric data associated with an entity comprises a sequence of time-ordered metric values that are recorded in spaced points in time called “time stamps.” A stream of metric data is simply called a “metric” and is denoted by

(yᵢ)ᵢ₌₁^{N}=(y(tᵢ))ᵢ₌₁^{N} (1)

where

N is the number of metric values in the sequence:

yᵢ=y(tᵢ) is a metric value;

tᵢ is a time stamp indicating when the metric value was generated and/or recorded in a data storage device; and

subscript i is a time stamp index i=1, . . . , N.

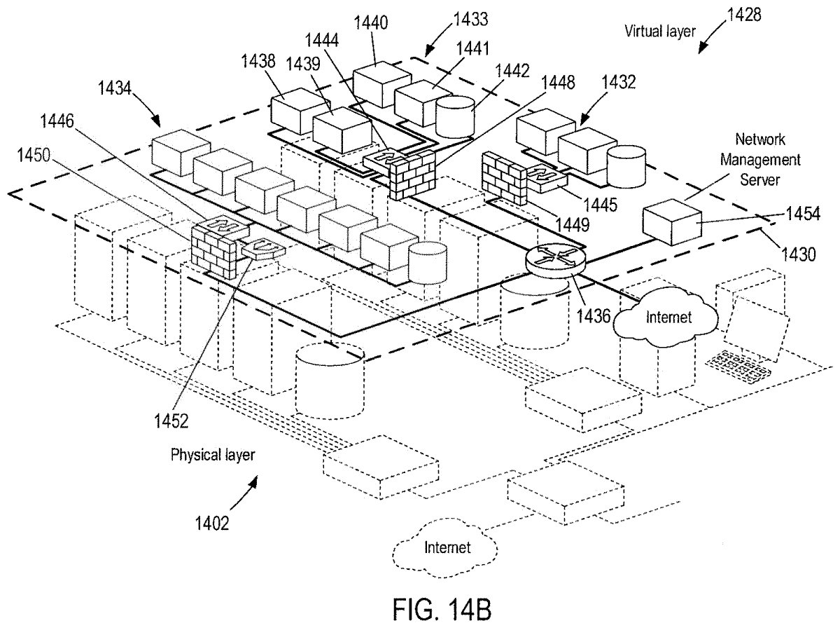

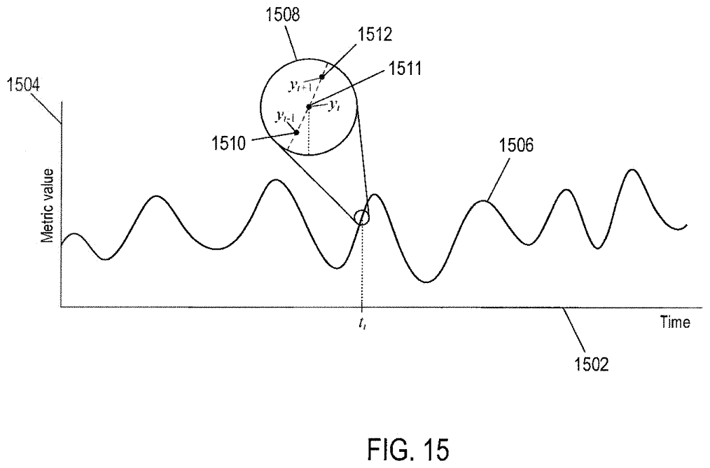

FIG. 15 shows a plot of an example metric. Horizontal axis 1502 represents time. Vertical axis 1504 represents a range of metric value amplitudes. Curve 1506 represents a metric as time series data. Although metrics are illustrated herein as curves, in practice. each metric comprises a sequence of discrete metric values in which each metric value is recorded in a data-storage device. FIG. 15 includes a magnified view 1508 of three consecutive metric values represented by points. Each point represents an amplitude, or magnitude, of the metric at a corresponding time stamp. For example, points 1510-1512 represent consecutive metric values (i.e.. amplitudes) yᵢ₋₁, yᵢ, and yᵢ₊₁ recorded in a data-storage device at corresponding time stamps tᵢ₋₁, tᵢ, and tᵢ₊₁. The example metric may represent usage of a physical or virtual object. For example, the metric may represent CPU usage of a core in a multicore processor of a server computer over time or CPU usage of a VM. The metric may represent the amount of virtual memory a VM uses over time. The metric may represent network throughput. packet drops, or traffic rate for a server computer, VM, a router interface or a switch port.

The KPls of certain entities, called “starting entities,” are inspected in a recent time interval for anomalous behavior. which is an indication of a performance problem. The problem observed at a starting entity may be correlated with one or more problems at other entities in the same network.

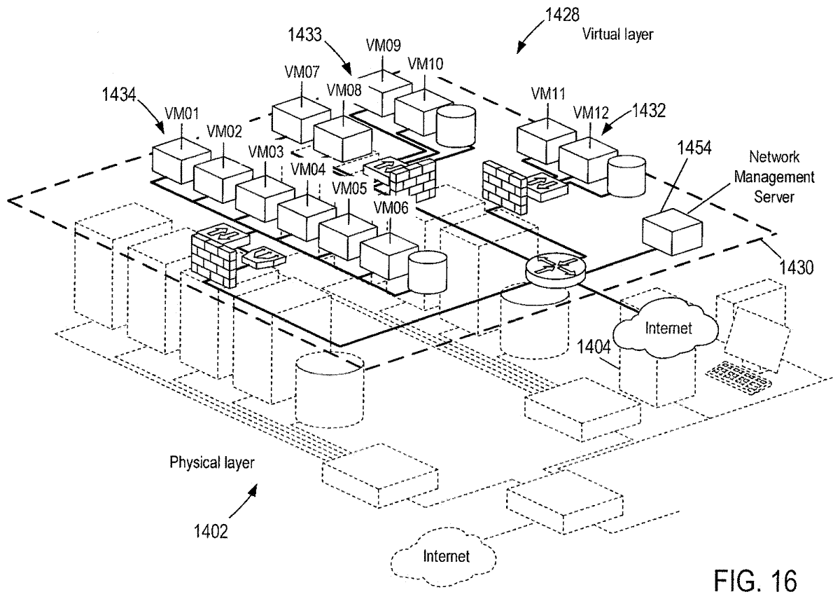

FIG. 16 shows objects of the example data center shown in FIG. 14B. The VMs 1432-1434 described above with reference to FIG. 14B are identified with labels VM01-VM12. Certain VMs, server computers, physical network components and virtual network components may be identified as starting entities and KPIs associated with the starting entities are sent to the network management server 1545. The KPIs of the starting entities are inspected for anomalous behavior by the network management server 1545 in a time interval.

Anomalous behavior of a starting entity may be determined by computing an absolute difference between a long-term mean of most recent metric values of a KPI and short-term mean of the most metric values of the KPI. The long-term time interval is denoted by [tⱼ, t_{f}], where tⱼ is the start time of the time interval and t_{f} is the end time of the time interval. A user selects the start time tⱼ and the end time t_{f} of the time interval. For example, the duration of the time interval may be thirty seconds, one minute. five minutes, ten minutes, thirty minutes, an hour, or any suitable period of time for detecting anomalous behavior associated with a metric. Let M_{L} be a set of most recent metric values of a KPI over a long-term interval given by M_{L}={y(tᵢ)|tᵢ ∈[tⱼ, t_{f}]}. Let M_{S} be the most recent metric values of the KPI over a short-term interval given by M_{S}={y(tᵢ)|tᵢ ∈[tₖ, t_{f}] and tⱼ<tₖ<t_{f}}. A long-term mean is calculated by

$${μ}_{L} = \frac{1}{n ( {M}_{L} )} {\sum }_{y ( {t}_{i} ) ∈ {M}_{L}} y ( {t}_{i} ) \qquad ( 2 a )$$

and a short-term mean is calculate by:

$${μ}_{S} = \frac{1}{n ( {M}_{s} )} {\sum }_{y ( {t}_{i} ) ∈ {M}_{s}} y ( {t}_{i} ) \qquad ( 2 b )$$

where

n(M_{L}) is the number of metric values in the set M_{L}; and

n(M_{S}) is the number of metric values in the set M_{S}.

When the absolute difference |μ_{L}-μ_{S}|>Th_{KPI}, where Th_{KPI} is an alert threshold for the KPI, an alert is triggered indicating anomalous behavior is occurring with the starting entity.

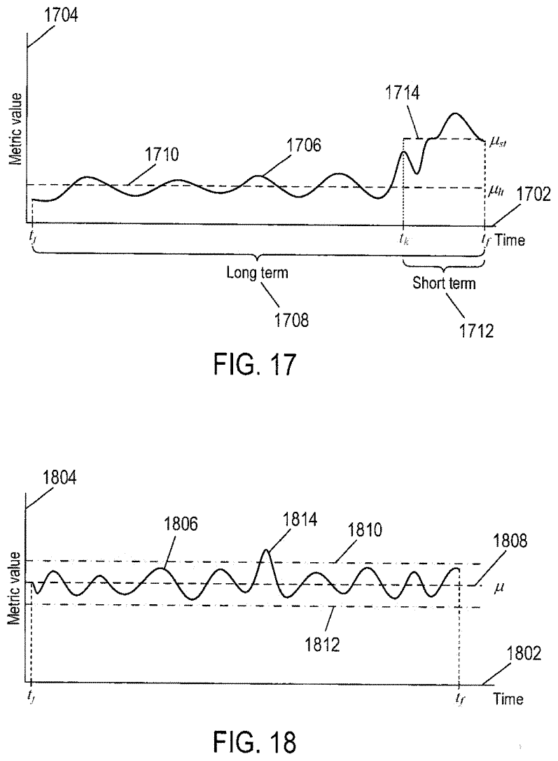

FIG. 17 shows an example KPI and associated long-term mean and short-term mean. Horizontal axis 1702 represents time. Vertical axis 1704 represents a range of metric values for the KPI. Curve 1706 represents metric values received and recorded by the network management server 1454 over a long-term interval [tⱼ, t_{f}] 1708. Dashed line 1710 represents the long-term mean of the metric values in the long-term interval [tⱼ, t_{f}] 1708. Note that short-term interval 1712 contains the most recent metric values in the long-term interval 1708. Dashed line 1714 represents the short-term mean of the KPI metric values in a short-term interval 1714. An alert is triggered in response to the condition |μ_{L}-μ_{S}>Th_{KPI}.

In an alternative implementation, an alert may be triggered when one or more metric values deviate from the mean of a KPI in the time interval [tⱼ, t_{f}]. In this implementation, the metric values of the KPI are assumed to be distributed according to a normal distribution centered at a mean for the KPI metric values in the time interval [tⱼ, t_{f}]. The mean of a sequence of N metric values produced in the time interval [tⱼ, t_{f}] is computed as follows:

$$μ = \frac{1}{N} {\sum }_{i = 1}^{N} y ( {t}_{i} ) \\ where {t}_{i} ∈ [ {t}_{j} , {t}_{f} ] \qquad ( 3 a )$$

The standard deviation of the sequence is given by

$$σ = \sqrt{\frac{1}{N} {\sum }_{i = 1}^{N} {( y ( {t}_{i} ) - μ )}^{2}} \qquad ( 3 b )$$

The mean and standard deviation are used to form upper and lower bounds μ+Aσ and μ-Aσ, respectively, for the KPI in the time interval. An alert is triggered when one or more metric values in the interval satisfy either of the following conditions:

y(tᵢ)>μ+Aσ or y(tᵢ)<μ−Aσ (3c)

where A is a user-selected positive number (i.e., A>0).

FIG. 18 shows an example KPI recorded in the time interval [tⱼ, t_{f}]. Horizontal axis 1802 represents time. Vertical axis 1804 represents a range of metric values for the KPI. Curve 1806 represents metric values recorded in the time interval [tⱼ, t_{f}]. Dashed line 1808 represents the mean of the metric values within the time interval. Dot-dashed lines 1810 and 1812 represent upper and lower bounds μ+Aσ and μ−Aσ, respectively. In this example, metric values 1814 lie outside the upper bound 1810, which triggers an alert.

In response to detection of anomalous behavior of a starting entity as described above with reference to Equations (2a)-(2b) and (3a)-(3c) and FIGS. 17 and 18, methods and systems display an alert in a graphical user interface (“GUI”) that identifies the starting entity exhibiting anomalous behavior and may also identify the metric that triggered the alert. The alert may be displayed in GUI of a system administrator console. on a console of an owner or developer of the application exhibiting the anomalous behavior. or the alert is sent in a message, such as an email message. to a system administrator and/or owner of the application.

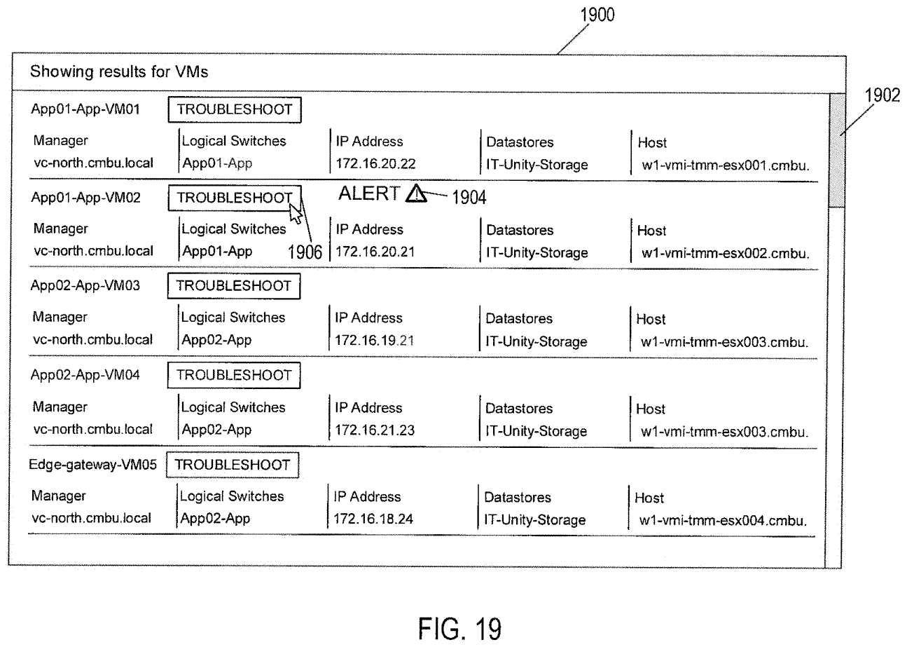

FIG. 19 shows an example GUI 1900 that displays a few of the VMs shown in FIG. 16. Each row identifies the name of an application executed in a VM, corresponding local switches, IP address of the VM, name of the data store used by the VM, and identities of a server computer that host the VM. For example, in the top row VM VM01 in FIG. 16 executes an application named “App01-App-VM01,” uses local switch “App02-App.” the VM01 has IP address “172.16.20.22,” stores data in data store “IT-Unity-Storage,” and is executed on a host server computer identified as “w1-vmi-tmm-esx001.cmbu.” In bottom row VM VM05 in FIG. 16 executes an edge services gateway named “Edge-gateway0VM05” that provides services such as firewall, network address translation, dynamic host configuration protocol, virtual private network, and load balancing. The GUI includes a scroll bar 1902 that enables a user to scroll up and down viewing the applications executed in the VMs shown in FIG. 16. In this example. a KPI of the VM VM02 has triggered an alert as described above with reference to Equations (2a)-(2b) and (3a)-(3c). The alert 1904 is displayed in the row corresponding to VM “App01-App-VM02.” Note that each row includes a button labeled “TROUBLESHOOT,” which enables a user to troubleshoot an entity for a network problem. In this example, because VM “App01-App-VM02” has been identified as exhibiting anomalous behavior, a user may begin troubleshooting the network associated with the VM VM02 by clicking on the “TROUBLESHOOT” button 1906.

Implementations are not limited to alerts generated by KPI metrics of VMs. Alerts may be generated for other entities that receive, send, and consume data over a physical or virtual network of a data center. In an alternative implementation. the GUI may display other network entities and a user may select a router interface, switch port, or an edge gateway as a starting entity for troubleshooting.

When a user clicks on a troubleshoot button associated with a starting entity, a dependency graph for the entity is constructed from entities that send data to and receive data from the starting entity over one or more networks of the data center. For example, when a user clicks on the “TROUBLESHOOT” button 1906 in the example GUI shown in FIG. 19. a dependency graph of entities in the data center that communicate with the VM VM02 of FIG. 16 is constructed. The network management server maintains a record of metrics for each of the physical and virtual entities of networks of the data center and IP addresses of the entities that send data to and receive data on virtual and physical networks of the data center and constructs the dependency graph. For example, in FIG. 14B, the network management server 1454 records network metrics, such as traffic rate, throughput, packet drops, latency, and TCP RTT (round trip time), for each entity connected to the virtual and physical networks of the data center shown in FIGS. 14A-14B and constructs a dependency graph for the selected starting entity VM02.

Entities in a dependency graph are categorized according to network capacity problems, traffic problems, and capacity/traffic problems. For capacity problems, the categories are virtual network vicinity, such as all the virtual network entities between a VM and an edge gateway (e.g., NSX edge owned by VMware, Inc.), containment relationship (e.g., host contains VM). physical network vicinity, such as all physical network entities starting from a pNIC of a host, to switch ports, switch, router and default gateway. For traffic problems, the categories include traffic relationships, such as all traffic flows passing through the entity. Methods maintain the configuration data and netflow data of each network of the data center, which enables methods to access the path taken by each flow through a network of physical and virtual elements. Capacity/traffic problems arise with a peer-to-peer network, such as peer-to-peer networking of VMs over a virtual network. Peer-to-peer networking is a distributed application architecture that partitions workloads between peer VMs. Peer VMs are equally privileged participants in execution of a distributed application. Each peer VM allows access to resources, such as processing power, disk storage or network bandwidth, directly available to other peer VMs on a network without use of a server computer to control access. In other words. each peer VM acts as a server for other peer VMs that share the same network. Peer VMs that have a resource-sharing relationship may be located on the same host. Peer VMs that have a common property/network path belong to the same application tier.

If the starting point of troubleshooting is a single starting entity, such as the VM VM02 in FIG. 19, the dependency graph for the VM VM02 includes peer VMs of the VM VM02. If the starting point of troubleshooting is a connectivity issue between two entities, the network path from one of the entities to other entities is determined and entities along the network path are considered related entities and added to the dependency graph.

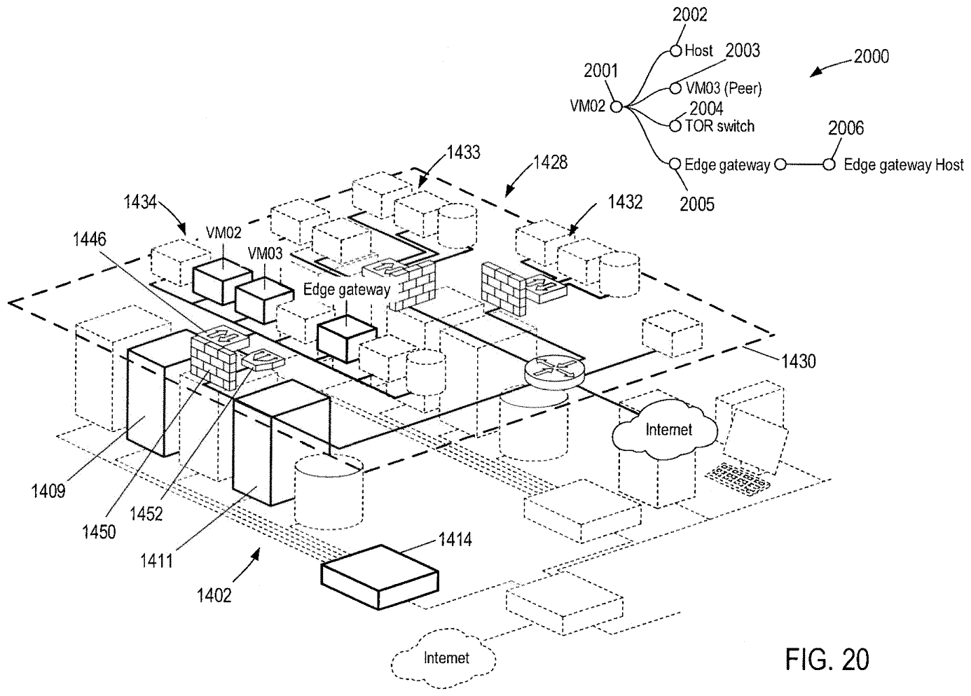

FIG. 20 shows a simple example of entities that send data to and receive data from starting entity VM02. VM03 is a peer VM to VM VM02 and “Edge gateway” maintains the firewall 1450, the virtual switch 1446, and load balancer 1452 for VMs on the virtual network 1434. The VMs VM02 and VM03 are hosted by server computer 1409 and edge gateway is hosted by server computer 1411. The VMs VM02 and VM03 are peers that send and receive data within the host server computer 1409. The edge gateway provides network edge security and gateway services for the VMs VM02 and VM03 on the 1434. The VM VM02 uses the switch 1414 to send and receive data from other devices.

FIG. 20 also shows an example entity graph 2000 of the example entities that are connected over virtual and physical networks of the data center to VM02. Nodes of the entity graph 2000 represent the entities that receive data from and send data to VM02. Because VM02 is the starting entity, VM02 is the root node 2001 of the entity graph 2000. Nodes 2002-2005 represent the host server computer 1409, peer VM VM03, switch 1414, and edge gateway that send data to and receive data from VM02. Node 2006 represents host server computer 1411 for the edge gateway. Nodes 2002-2006 are called “related entities.” Each node has corresponding metrics that characterize performance of the node itself and has metrics that characterize the condition of resources and network performance at the node. Edges represent connections or relationships between metrics of the starting and related entities.

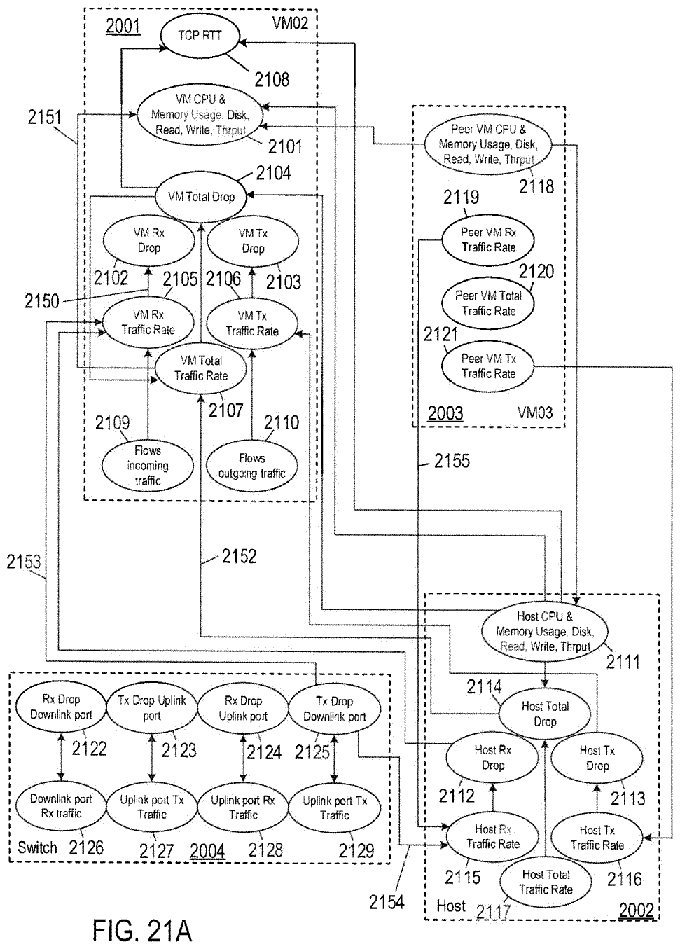

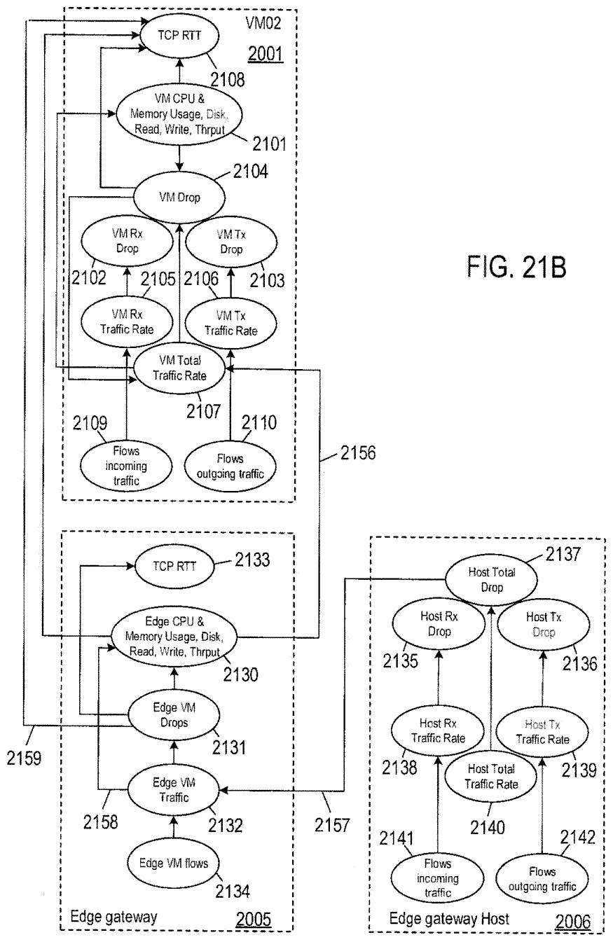

FIGS. 21A-21B show different portions of an example dependency graph for stating entity VM02 and related entities of the entity graph 2000. Note that starting entity. VM02, is shown in FIG. 21A and FIG. 21B. Nodes of the dependency graph are metrics that represent use of computational resources of the starting and related entities and network performance metrics. Nodes also represent metrics of entities that provide and/or consume network and storage resources used by the entity. Directed edges of the dependency graph represent a connection between metrics in which the performance represented by one metric depends on the performance represented by the other metric. Dashed-line rectangles correspond to entities represented by nodes 2101-2106 in the entity graph 2000 shown in FIG. 20. Nodes within each rectangle are the metrics associated with that entity. Note that a number of the nodes include “Rx” and “Tx” abbreviations for receive and transmit, respectively.

Nodes 2101-2110 are the metrics of starting entity VM02. Node 2101 represents a number of metrics of computational resources of VM02. For example, node 2101 includes the following metrics: CPU usage, CPU wait time, memory, number of disk reads, number of disk writes, and throughput for VM02. Nodes 2102-2104 are metrics that represent number of packets dropped by VM02. Node 2102 is a metric called “VM Rx Drop” that represents the number packets dropped by VM02 before the application executed in VM02 receives the packets. Node 2003 is a metric called “VM Tx Drop” that represents the number of packets dropped by NM02 before the packets are transmitted to other entities on the network. Node 2104 is a metric called “VM Drop” that represents the total number of packets dropped by VM02 (i.e., sum of VM Rx Drop and VM Tx Drop). Nodes 2105-2107 are metrics that represent traffic rates for VM02. Node 2105 is a metric called “VM Rx Traffic Rate” that represents the number of packets received by VM02 per unit time (e.g., bytes per second). Node 2006 is a metric called “VM Tx Traffic Rate” that represents the number of packets transmitted by VM02 per unit time. Node 2107 represents the total number of packets received and transmitted by VM02 per unit time. Node 2108 is a TCP RTT (“transmission control protocol return-trip time”) metric. TCP RTT metric is formed by VM02 sending a TCP synch packet to a related entity on the network (timer begins). such as a peer VM. and the related entity sends a TCP synch acknowledgement packet back to VM02 (timer ends). A TCP RTT metric value is the total time between when the TCP synch is sent by VM02 and the TCP synch acknowledgement is received by VM02. Node 2109 is a flow metric for packets received by VI1,102. Node 2110 is a flow metric for packets sent by the VM02.

Nodes 2111-2117 are the metrics of host 2002 of VM02. Node 2111 represents CPU usage, CPU wait time. memory, number of disk reads, number of disk writes, and throughput for host 2002. Node 2112 is a metric called “Host Rx Drop” that represents the number of packets that are received and dropped by the host 2002. Node 2113 is a metric called “Host Tx Drop” that represents the number of packets dropped by the host 2002 before the packets are sent to other entities on the network. Node 2114 is a metric called “Host Drop” that represents the total number of packets dropped by host 2002 (i.e., sum of Host Rx Drop and Host Tx Drop). Node 2115 is a metric called “Host Rx Traffic Rate” that represents the number of packets received by the host 2002 per unit time. Node 2116 is a metric called “Host Tx Traffic Rate” that represents the number of packets sent by the host 2002 per unit time. Node 2117 represents the total number of packets received and transmitted by the host 2002 per unit time.

Nodes 2118-2121 are the metrics of peer VM03 2003. Node 2118 represents a number of metrics of VM03, including CPU usage, CP 11 wait time, memory, number of disk reads. number of disk writes, and throughput. Node 2119 is a metric called “Peer VM Rx Traffic Rate” that represents the number of packets received by VM03 per unit time. Node 2120 is a metric called “Peer VM Tx Traffic Rate” that represents the number of packets sent by the VM03 per unit time. Node 2121 represents the total number of packets received sent by VM03 per unit time.

Nodes 2122-2129 are the metrics of switch 2004. Node 2122 is a metric called “Rx Drop Downlink Port” that represents the number of packets received and dropped at a downlink port of the switch 2004. Node 2123 is a metric called “Tx Drop Uplink Port” that represents the number of packets dropped before being transmitted using an uplink port of the switch 2004. Node 2124 is a metric called “Rx Drop Uplink Port” that represents the number of packets received and dropped at an uplink port of the switch 2004. Node 2125 is a metric called “Tx Drop Downlink Port” that represents the number of packets dropped before being transmitted using an uplink port of the switch 2004. Node 2126 is a metric called “Downlink Port Rx traffic” is the amount of data received at a downlink port of the switch 2004. Node 2127 is a metric called “Uplink Port Tx traffic” is the amount of data transmitted at an uplink port of the switch 2004. Node 2128 is a metric called “'Uplink Port Rx traffic” is the amount of data received at an uplink port. Node 2129 is metric called “Uplink Port Tx traffic” is the amount of data transmitted from an uplink port.

Nodes 2130-2134 are metrics of VM05, which executes edge gateway 2005. Node 2130 represents metrics of VMOS, including CPU usage. CPU wait time, memory, number of disk reads, number of disk writes, and throughput for VM05. Node 2131 is a metric that represents the number of packets dropped by VM05. Node 2132 is a metric that represents the traffic rate at VMOS. Node 2133 is TCP RTT metric for VM05. Node 2134 is a metric that represents the flow data at VM05.

Nodes 2135-2141 are the metrics of host 2006 of VMOS. Node 2135 is a metric called “Host Rx Drop” that represents the number of packets received and dropped by the host 2006. Node 2136 is a metric called “Host Tx Drop” that represents number of packets dropped by the host 2006 before the packets are sent to other entities on the network. Node 2137 is a metric called “Host Drop” that represents the total number of packets dropped by host 2006 (i.e., sum of Host Rx Drop and Host Tx Drop). Node 2138 is a metric called “Host Rx Traffic Rate” that represents the number of packets received by the host 2006 per unit time. Node 2138 is a metric called “Host Tx Traffic Rate” that represents the number of packets sent bv the host 2006 per unit time. Node 2140 represents the total number of packets received and transmitted by the host 2006 per unit time. Node 2141 is a flow metric for packets received by host 2006. Node 2142 is a flow metric for packets sent by the host 2006.

Directional edges of the example dependency graph shown in FIGS. 21A-21B represent connections between metrics in which the performance represented by one metric depends on the performance represented by the other metric. For example, in FIG. 21A. edge 2150 represents a connection in which VM Rx Drops of node 2102 depend on the VM Rx Traffic Rate at node 2105. As the VM Rx Traffic Rate increases (decreases), Rx Drops also increases (decreases). Edge 2151 represents a connection in which CPU usage, CPU wait time, and memory of VN102 of node 2101 depend on VM total traffic rate of node 2107. As the total traffic rate at VM02 increases (decreases), CPU usage. CPU wait time, and memory usage increase (decrease). Edge 2152 represents a connection in which VM Total Traffic Rate of node 2107 depends on Host Total Drop of node 2114. Edges 2153 and 2154 represent connections in which Host Rx Traffic Rate at node 2115 and VM Rx Traffic Rate at node 2105 depend on Tx Drop Downlink Port at node 2125. As packet drops at a downlink port of the switch 2004 increase (decrease), traffic rates at the host 2117 and VM02 are affected. Edge 2155 represents a connection in which Host Rx Traffic Rates represented by node 2115 depends on Peer VM Rx Traffic Rate represented by node 2119. In FIG. 21B. edge 2156 represents a connection in which VM Total Traffic Rate of VM02 at node 2107 depends on edge CPU usage, CPU wait time, and memory of the edge gateway executed by VMOS at node 2130. Edge 2157 represents a connection in which Edge VM Traffic Rate of edge gateway represented by node 2132 depends on VM Total Drop 2137 of the edge gateway host 2006 represented by node 2137. Edge 2158 represents a connection in which edge gateway CPI >usage, CPU wait time, and memory of edge gateway VMOS as represented by node 2130 depends on edge VM Traffic Rate represented by node 2132. Edge 2159 represents a connection in which TCP RTT of V11/102 as represented by node 2108 depends on edge VM Drops represented by node 2131.

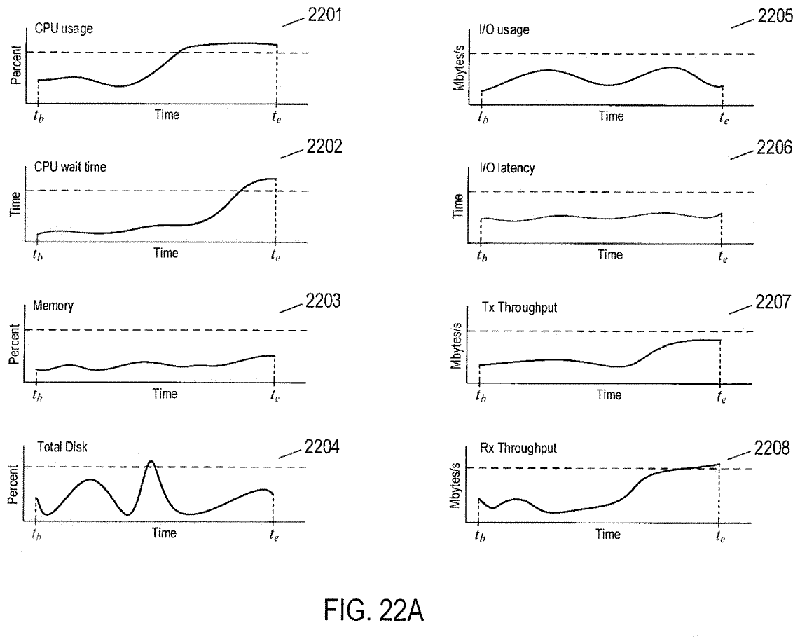

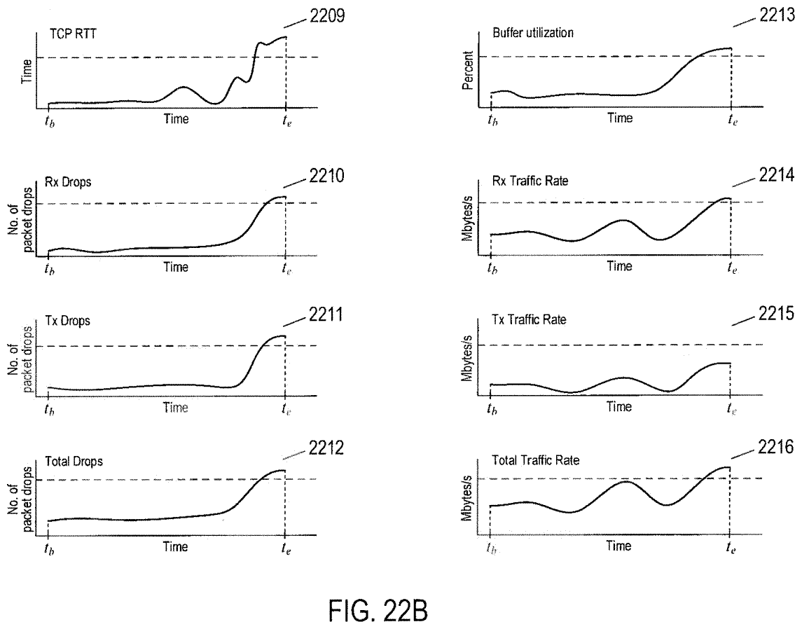

FIGS. 22A-22B show example plots of metrics associated with an entity of a dependency graph. Each plot represents metric values of a metric recorded over a user-selected time interval [t_{b}, tₑ], where t_{b} and tₑ represent the beginning time and ending time of the time interval. For example, the time interval [t_{b}, tₑ] may include the start time for the anomalous behavior of the KPI. Each plot includes a time axis that contains the time interval [t_{b}, tₑ] and a vertical axis that represents a range of metric values for the metric. Curves represent the metric values of different metrics recorded over the time interval [t_{b}, tₑ]. Each plot is labeled to identify a corresponding metric of the entity. In the example of FIGS. 22A-22B, the plots correspond to nodes of the starting entity VM02 in FIGS. 21A-21B. Plots 2201-2208 represent CPU usage, CPU wait time, memory, total disk, I/O usage and latency, and Tx and Rx throughput for the VMO2 over the time interval [t_{b}, t₄] and are represented by the node 2101 in FIGS. 21A-21B. Plot 2209 represents TCP RTT of VM02 over the time interval [t_{b}, tₑ] and is represented by node 2108 in FIGS. 21A-21B. Plots 2210-2212 are Rx, Tx, and total packet drops of VM02 over the time interval [t_{b}, tₑ] and are represented by nodes 2102-2104 in FIGS. 21A-21B. Plots 2214-2216 are Rx. Tx, and total traffic rates of VM02 over the time interval [t_{b}, tₑ] and are represented by nodes 2105-2107 in FIGS. 21A-21B. Plot 2213 is buffer utilization for VMO2 over the time interval [t_{b}, tₑ].

Methods and systems perform anomaly detection on each of the metrics of the starting entity and each of the metrics of the related entities of the dependency graph over the time interval [t_{b}, tₑ]. In one implementation, anomaly detection is performed on each of the metrics of the starting entity and the related entities using an absolute difference between a long-term mean over metric values recorded in the time interval [t_{b}, tₑ] and a short-term mean of the most recent metric values in the time interval [tₖ, tₑ] as described above with reference to Equations (2a) and (2b). Anomaly detection described above with reference to Equations (2a) and (2b) is performed for each metric of the starting entity and each metric of the related entities in the time interval [t_{b}, tₑ]. An alert is triggered in response to |μ_{L}−μ_{S}|>Thₐₗₑᵣₜ, where μ_{L} is the long-term mean of the metric, μ_{S} is the short-term mean, and Thₐₗₑᵣₜ is an alert threshold which may be different for each metric. An anomaly score for the metric is given by AS(y)=|μ_{L}-μ_{S}|.

In another implementation, anomaly detection is performed on each of the metrics of the starting entity and each of the related entities based on metric values that deviate from the mean of the metric over the time interval [t_{b}, tₑ] as described above with reference to Equations (3a) and (3b). An alert is triggered in response to y(tᵢ)>μ+Aσ for at least one time stamp tᵢ ∈[t_{b}, tₑ] as described above with reference to Equations (3a), (3b), and (3c). For example, each of the plots 2201-2216 in FIGS. 22A-22B includes a corresponding threshold +Au represented by dashed lines. Plots 2201-2202, 2204, 2208, 2209-2214, and 2216 all show metric values that violate corresponding thresholds over the time interval [t_{b}, tₑ]. A separate alert is triggered for each metric that violates a corresponding threshold over the time interval [t_{b}, tₑ]. For example, in plot 2201, an alert is triggered indicating that CPU usage for VM02 has exceeded the corresponding threshold in the time interval [t_{b}, tₑ]. An anomaly score is given by AS(y)=max|y(tᵢ)−(μ+Aσ)|. When y(tᵢ)<μ−Aσ for at least one time stamp tᵢ ∈[t_{b}, tₑ], the anomaly score is given by AS(y)=max|y(tᵢ)−(μ−Aσ)|.

In still another implementation, anomaly detection is performed on each of the metrics of the starting entity and each of the related entities based on a median absolute deviation (“MAD”) between the median of metric values in the time interval [t_{b}, tₑ] and the median of metric values in a historical time interval. For a sequence of metric values y₁, y₂, y₃. . . . , y_{N} in the time interval [t_{b}, tₑ], the MAD is the median of absolute deviations from the median of the sequence as follows:

MAD=med|yᵢ−\tilde{y}| (4a)

where

\tilde{y}=med (y₁, y₂, y₃, . . . y_{N}), and

“med” represents the median.

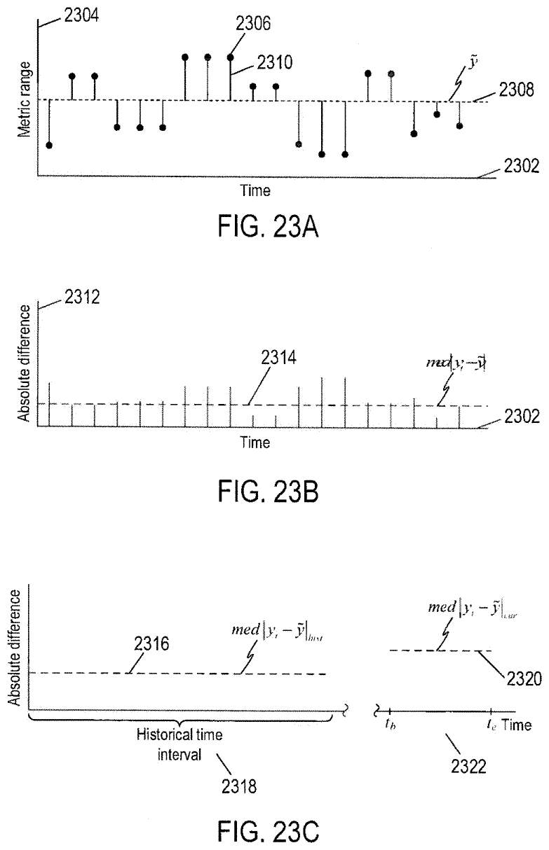

FIGS. 23A-23C show a MAD for an example set of metric values of a metric y. FIGS. 23A shows a plot of example metric values of a metric. Horizontal axis 2302 represents time. Vertical axis 2304 represents a range of metric values. Dots, such as dot 2306, represent metric values of a metric, such as CPU usage, traffic rate or drops. Dashed line 2308 represents a median of the metric values and is denoted by Y. Vertical line segments between the metric values and the median 2308 represent the difference yᵢ-\tilde{y}. FIG. 23B shows a plot of absolute values of the differences between the metric values and the median 2308 in FIG. 23B. Vertical axis 2312 represents the range of absolute differences. Vertical line segments represent absolute values of the difference yᵢ-\tilde{y}(i.e., |yᵢ−\tilde{y}|). Long dashed line 2314 represents the MAD. The MAD is used to detect anomalous behavior recorded in a metric. FIG. 23C shows a plot of a MADₕᵢₛₜ=med|yᵢ−\tilde{y}|ₕᵢₛₜ 2316 computed for a metric based on historical metric values recorded in a historical time interval 2318 and a plot of a current MAD_{cur}=med|yᵢ−\tilde{y}|_{cur} 2320 computed for the metric based on current metric values recorded in the time interval [t_{b}, tₑ] 2322. The absolute difference between the historical MAD and the current MAD gives an anomaly score given by

AS(y)=|med|yᵢ−\tilde{y}|_{cur}−med|yᵢ−\tilde{y}|ₕᵢₛₜ| (4b)

When the anomaly score of a metric y satisfies the condition AC(y)>Th_{MAD}, where Th_{MAD} is a threshold, the median value of the metric has shifted away from normal and is an indication of anomalous behavior in the time interval [t_{b}, tₑ].

Methods and systems determine an amount of correlation between metrics of the starting entity and metrics of the related entities that correspond to edges in the dependency graph and determine the amount of correlation between metrics of related entities that correspond to edges in the dependency graph. In one implementation. correlations are determined by computing a correlation coefficient for each edge of the dependency graph that connects a metric of the starting entity with a metric of the related entities and for each edge of the dependency graph that connects the related entities. However. the metrics of the starting entity and related entities of the dependency graph are typically not synchronized. For example, metric values of certain metrics may be recorded at periodic intervals, but the periodic intervals of the metrics may be different. Moreover, metric values of some metrics may be recorded at nonperiodic intervals and are not synchronized with the time stamps of other metrics.

To determine a correlation coefficient for metrics connected by an edge of a dependency graph, the metrics are first time synchronized. Let y^{(t)}=(y⁽ⁱ⁾(t′₁), . . . , y⁽ⁱ⁾(t′_{K})) denote a first metric and let y^{(j)}=(y^{(j)}(t″₁), . . . , y^{(j)}(t″_{L})) denote a second metric that correspond to nodes of a dependency graph, where y⁽ⁱ⁾ and y^{(j)} are connected by an edge of the dependency graph, superscripts (0 and (j) denote different metrics, t′₁, . . . , t′_{K} ∈[t_{b}, tₑ]. t″₁, . . . , t″_{L} ∈[t_{b}, tₑ]. K and L represent the number of time stamps in y⁽ⁱ⁾ and y^{(j)}, respectively. For example, the metric y⁽ⁱ⁾ may be CPU usage, Rx drops, Tx traffic rate, or TCP RTT of a starting entity and the metric y^{(j)} may be throughput. Tx traffic rate, or total drops of a related entity in the dependency graph. Synchronization is performed to align the metric values of the metrics y⁽ⁱ⁾ and y^{(j)} to the same time stamps denoted by

y⁽ⁱ⁾→x⁽ⁱ⁾=(x⁽ⁱ⁾(t₁), . . . , x⁽ⁱ⁾(t_{N})) (5a)

y^{(j)}→x^{(j)}=(x^{(j)}(t₁), . . . , x^{(j)}(t_{N})) (5b)

Synchronized may be performed by computing a run-time average of metric values in a sliding time window. In one implementation, average metric values are computed in overlapping sliding time windows centered at each time stamp of a general set of uniformly spaced time stamps. In another implementation, median metric values are computed in overlapping sliding time windows centered at each time stamp of a general set of uniformly spaced time stamps.

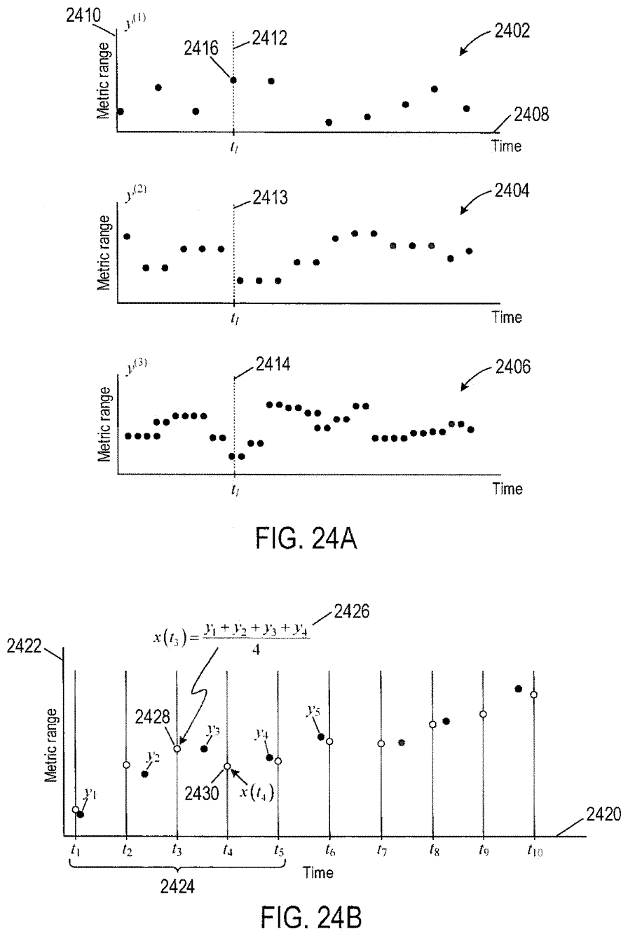

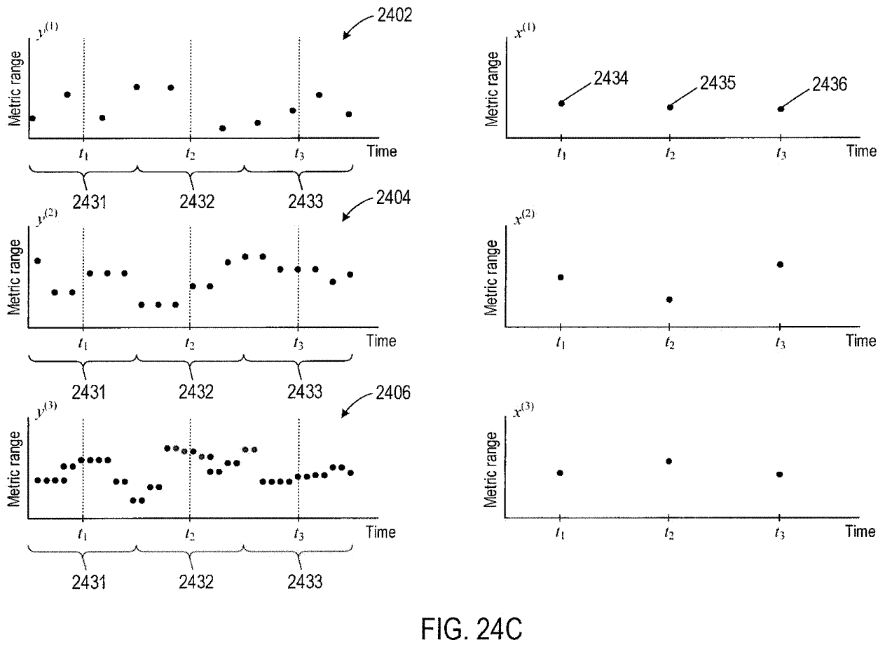

FIG. 24A shows plots 2402, 2404, and 2406 of three example unsynchronized metrics denoted by y⁽¹⁾, y⁽²⁾, and y⁽³⁾ and recorded in the time interval [t_{b}, tₑ]. Horizontal axes, such as horizontal axis 2408, represents the same portion of the time interval [t_{b}, tₑ]. Vertical axes, such as vertical axis 2410, represent ranges of metric values for the respective metrics y⁽¹⁾, y⁽²⁾, and y⁽³⁾. The metrics y⁽¹⁾, y⁽²⁾, and y⁽³⁾ may represent CPU usage. Tx drops, and throughput. Dots represent metric values recorded at different time stamps. Dashed lines 2412-2414 mark the same time stamp, tₖ, in the time interval. Metric y⁽¹⁾ has a metric value 2416 recorded at time stamp tₖ. However, the metrics y⁽²⁾ and y⁽³⁾ do not have metric values recorded at the same time stamp tₖ. As a result, the metrics y⁽¹⁾, y⁽²⁾, and y⁽³⁾ are not synchronized.

FIG. 24B shows a plot of metric values synchronized to a general set of uniformly spaced time stamps. Horizontal axis 2420 represents time. Vertical axis 2422 represents a range of metric values. Solid dots represent metric values recorded at irregularly spaced time stamps. Marks located along time axis 2420 represent time stamps of the general set of uniformly spaced time stamps. Note that the metric values are not aligned with the time stamps of the uniformly spaced time stamps. Open dots represent average metric values aligned with the time stamps of the uniformly spaced time stamps. Bracket 2424 represents a sliding time window centered at a time stamp t₃. The metric values y₁, y₂, y₃, and y₄ have time stamps within the sliding time window 2424 and are averaged 2426 to obtain synchronized metric value 2428 at the time stamp t₃ of the general set of uniformly spaced time stamps. Average metric value 2430 is computed by centering the time window at time stamp t₄ and averaging metric values y₂, y₃, y₄, and y₅.

FIG. 24C shows plots 2402, 2404, and 2406 of the three example unsynchronized metrics denoted by y⁽¹⁾, y⁽²⁾, and y⁽³⁾. Times t₁, t₂, and t₃ along the time axes represent three time stamps of a general set of uniformly spaced time stamps. Brackets, such as brackets 2431-2433, represent nonoverlapping time windows centered on the time stamps t₁, t₂, and t₃. Average metric values are computed in the nonoverlapping time windows centered at each of the time stamps t₁, t₂, and t₃. For example, average metric values 2434-2436 at corresponding time stamps t₁, t₂, and t₃ are the average values of the metric values in the time windows 2431-2433.

A correlation coefficient is computed between two synchronized metrics x⁽ⁱ⁾ and x^{(j)} of an edge in a dependency graph as follows:

$$corr ( i , j ) = \frac{{\sum }_{n = 1}^{N} ( {x}_{n}^{( i )} - {μ}^{( i )} ) ( {x}_{n}^{( j )} - {μ}^{( j )} )}{{σ}^{( i )} {σ}^{( j )}} \\ where {μ}^{( j )} = \frac{1}{N} {\sum }_{n = 1}^{N} {x}_{n}^{( j )} \\ {σ}^{( i )} = \sqrt{\frac{1}{N} {\sum }_{n = 1}^{N} ( {x}_{n}^{( i )} - {μ}^{( i )} )} \\ {μ}^{( j )} = \frac{1}{N} {\sum }_{n = 1}^{N} {x}_{n}^{( j )} \\ and \\ {σ}^{( j )} = \sqrt{\frac{1}{N} {\sum }_{n = 1}^{N} ( {x}_{n}^{( j )} - {μ}^{( j )} )} \qquad ( 6 )$$

When the absolute value of the correlation coefficient satisfies the condition. |corr(i, j)|>Th_{corr}, where Th_{corr} is correlation threshold, the metrics y⁽ⁱ⁾ and y^{(j)} are correlated metrics connected by an edge of the dependency graph. When correlation satisfies the condition |corr(i, j)|>Th_{corr}, anomalous behavior exhibited by the metrics y⁽ⁱ⁾ and y^{(j)} is likely connected.

Methods perform changepoint detection on the metrics connected by an edge in the dependency graph. Change point detection may be performed using Kullback-Leibler (“KL”) divergence for each of the metrics connected by an edge in the dependency graph. KL divergence is performed by determining a probability distribution for a metric over a historical time interval and determining a probability distribution for the metric over the time interval [t_{b}, tₑ]. A probability distribution is computed for a metric by partitioning the range of metric values into a set of B adjacent and equal size bins denoted by {b₁, b₂, . . , b_{B}}. The number of metric values in each bin is denoted by n(bᵢ), where bᵢ is the i-th bin in the set of bins. A historical probability distribution of the range of metric values for the metric is obtained by dividing the number of metric values in each bin by the total number of metric values recorded over the historical time interval:

$$P = \{ P ( {b}_{1} ) , P ( {b}_{2} ) , … , P ( {b}_{B} ) \} \\ where P ( {b}_{i} ) = \frac{n ( {b}_{i} )}{{N}_{hist}} \qquad ( 7 a )$$

n(bᵢ) is the number of metric values in the i-th bin over the historical time interval: and

Nₕᵢₛₜ is the number of metric values recorded over the historical time interval.

For example, P(bᵢ) is the probability that a metric value will lie within the bin bᵢ. The historical probability distribution P serves as a baseline for detecting anomalous behavior. A probability distribution of the range of metric values for the metric generated in the time interval [t_{b}, tₑ] is given by:

$$Q = \{ Q ( {b}_{1} ) , Q ( {b}_{2} ) , … , Q ( {b}_{B} ) \} \\ where Q ( {b}_{i} ) = \frac{m ( {b}_{i} )}{{N}_{c u r}} \qquad ( 7 b )$$

m(bᵢ) is the number of metric values in the i-th bin of the time interval [t_{b}, tₑ];

N_{cur} is the number of metric values recorded in the time interval [t_{b}, tₑ].

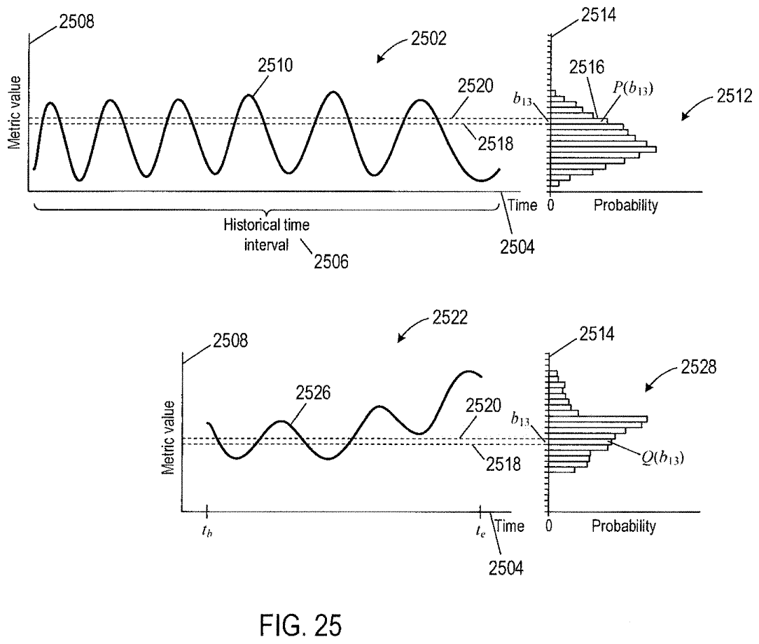

FIG. 25 shows example probability distributions for metric values of a metric recorded in a historical time interval and metric values of the same metric recorded in the time interval [t_{b}, tₑ]. FIG. 25 shows a plot 2502 of the metric recorded over a historical time interval. Horizontal axis 2504 represents time that includes the historical time interval 2506. Vertical axis 2508 represents a range of metric values. Curve 2510 represents metric values of the metric recorded in the historical time interval. FIG. 25 shows a probability distribution 2512 of the metric values recorded in the historical time interval. Axis 2514 represents the range of metric values partitioned into 28 (i.e., B=28) equal size bins with boundaries identified by regularly spaced marks. Probabilities of the probability distribution 2512 are computed for each bin according to Equation (6a) and are represented by bars. For example, bar 2516 represents the probability P(b₁₃) computed based on the number of metric values of the metric 2510 that lie between boundaries 2518 and 2520 of bin b₁₃ according to Equation (6a). FIG. 25 shows a plot 2522 of the metric recorded over the time interval [t_{b}, tₑ]. Horizontal axis 2524 represents time that includes the time interval [t_{b}, tₑ]. Curve 2526 represents metric values of the metric recorded in the time interval [t_{b}, tₑ]. FIG. 25 shows a probability distribution 2528 of the metric values recorded in the time interval [t_{b}, tₑ]. Probabilities of the probability distribution 2528 are computed for each bin according to Equation (6a) and are represented by bars. For example, bar 2530 represents the probability Q(b₁₃) computed based on the number of metric values that lie between boundaries 2518 and 2520 of bin b₁₃ according to Equation (6a).

KL-divergence of the probability distributions P and Q in corresponding Equations (7a) and (7b) is given by

$${D}_{KL} ( P ‖ Q ) = {\sum }_{i = 1}^{B} P ( {b}_{i} ) log ( \frac{P ( {b}_{i} )}{Q ( {b}_{i} )} ) \qquad ( 7 c )$$

The value of KL-divergence is a measure of how close the probability distribution Q of the metric in the time interval [t_{b}, tₑ] is to the baseline probability distribution P for the metric. When KL-divergence D_{KL} (P∥Q) equals zero, the probability distributions P and Q are identical. In other words, there is no appreciable change in the distribution of metric values recorded in the time interval [t_{b}, tₑ] from the distribution of metric values recorded in the historical time interval. By contrast, the larger the KL-divergence. the larger the difference between the probability distributions P and Q. In other words, there is an appreciable change in the distribution of metric values recorded in the time interval [t_{b}, tₑ] from the distribution of metric values recorded in the historical time interval. When D_{KL} (P∥Q)>Th_{CE}, where Th_{CE} is a change event threshold, the metric has changed from the baseline.

In another implementation. the divergence between the pair of distributions P and Q may be computed using the Jensen-Shannon divergence:

$${D}_{JS} ( P ‖ Q ) = {\sum }_{i = 1}^{B} {M}_{i} {log}_{2} {M}_{i} + \frac{1}{2} [ {\sum }_{i = 1}^{B} P ( {b}_{i} ) {log}_{2} P ( {b}_{i} ) + {\sum }_{i = 1}^{B} Q ( {b}_{i} ) {log}_{2} Q ( {b}_{i} ) ] \\ where {M}_{i} = ( P ( {b}_{i} ) + Q ( {b}_{i} ) ) / 2. \qquad ( 7 d )$$

The closer D_{JS}(P∥Q) is to zero, the more similar the distributions P and Q are to each other. The closer D_{JS}(P∥Q) is to one, the distributions P and Q diverge from one another.

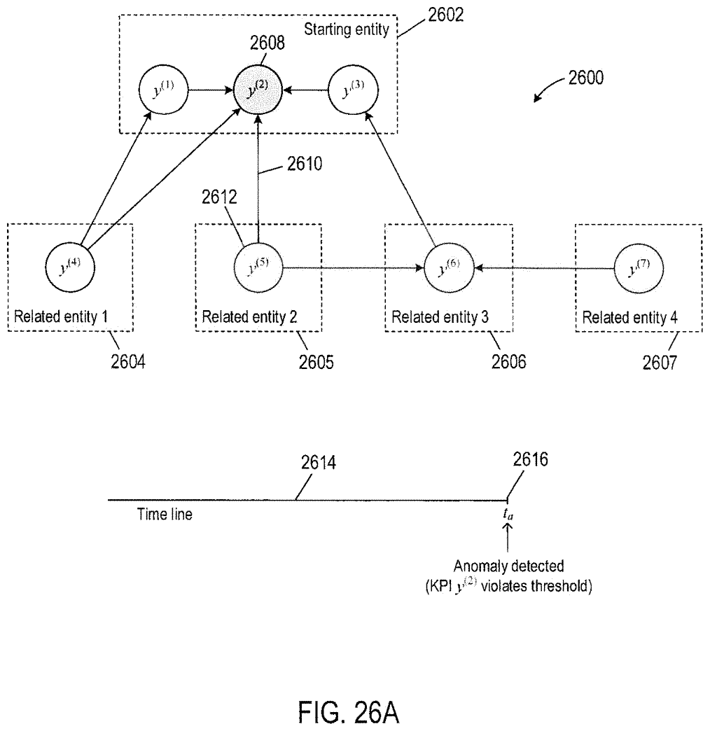

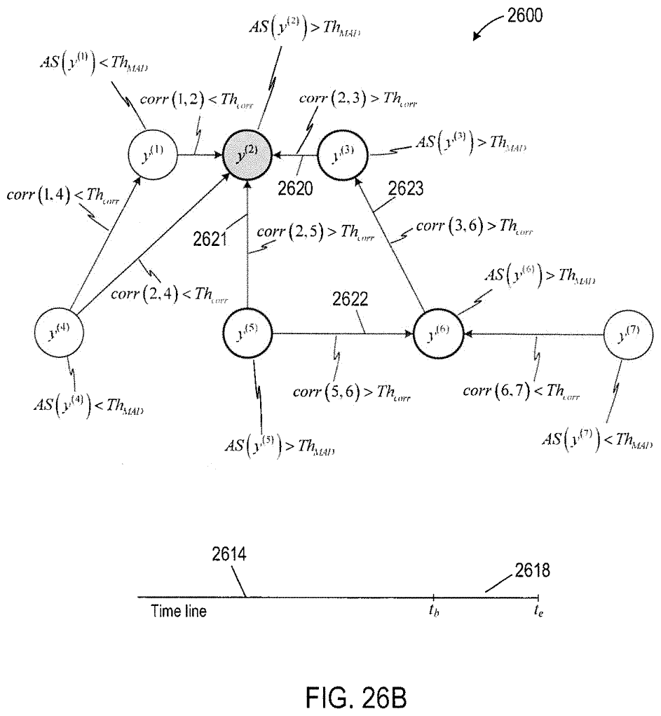

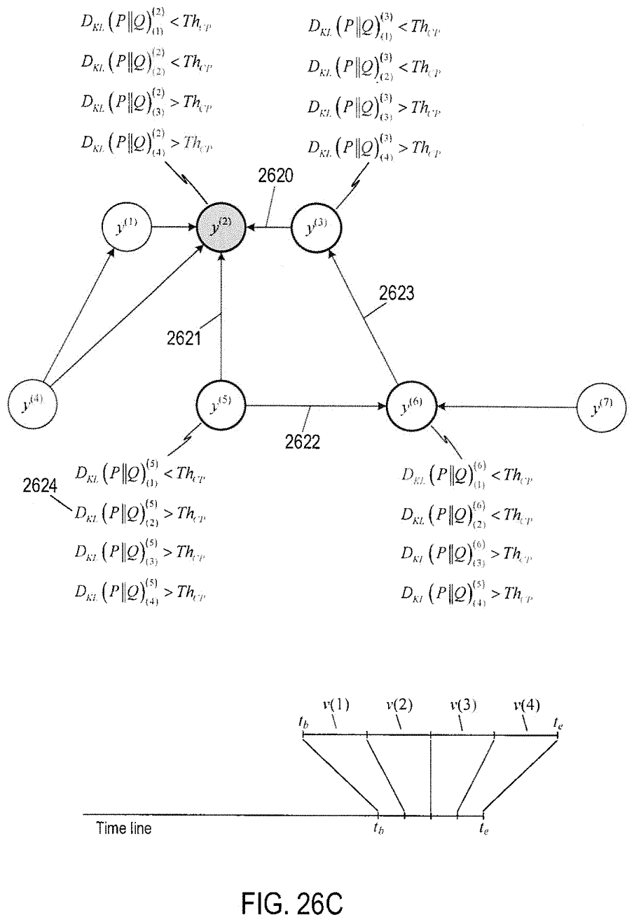

FIGS. 26A-26B show an example of anomaly scores, correlations, and change events calculated for metrics of entities in an example dependency graph 2600. FIG. 26A shows the example dependency graph for a starting entity 2602 and four related entities 2604-2607, For example, the starting entity 2602 may be a VM executing in a host, related entities 2604-2606 may be peer VMs to the starting entity 2602, and related entity 2607 may be an edge gateway. Alternatively, starting entity 2602 may be a virtual switch, related entities 2604-2606 may be VMs, and related entity 2607 may be a host. Nodes of the dependency graph represents metrics of the entities and are denoted by y⁽¹⁾, y⁽²⁾, y⁽³⁾, y⁽⁴⁾, y⁽⁵⁾, y⁽⁶⁾, and y⁽⁷⁾ For example, starting entity 2602 has nodes y⁽¹⁾, y⁽²⁾, and y⁽³⁾ and related entity 2604 has a node y⁽⁴⁾. The nodes may represent different virtual and physical resource metrics, such as CPU usage, CPU wait time, and memory. and represent network metrics such as Tx and Rx drops. Tx and Rx traffic rates, TCP RTT, I/O usage and I/O latency. Edges of the dependency graph 2600 are represented by directional arrows. Each edge represents a dependent relationship between the metrics represented by the nodes. For example. edge 2610 indicates that the metric y⁽²⁾ 2608 depends on the metric y⁽⁵⁾ 2612. The dependency graph 2600 may be generated by VMware's vRNI. In this example, metric y⁽²⁾ is a KPI as represented by shading of the node 2608. The metric y⁽²⁾ is checked for anomalous behavior as described above with reference to Equations (2a) and (2b) and Equations (3a)-(3c). FIG. 26A includes a timeline 2614 with a mark 2616 that represents point in time, tₐ, when the metric y⁽²⁾ violates a threshold, which triggers an alarm indicating a problem has occurred with the starting entity 2602.

In response to selecting the starting entity 2602 for troubleshooting, an anomaly score is computed for each metric of the starting entity and each metric of the related entities as describe above with reference to Equations (4a) and (4b). Correlations are also computed for the metrics associated with each edge of the dependency graph. FIG. 26B shows example anomaly scores computed for each of the nodes and correlation coefficients computed for each of the edges of the example dependency graph 2600 within the time interval [t_{b}, tₑ] 2618. The beginning time t_{b} and ending time tₑ of the time interval [t_{b}, tₑ] 2618 may be selected to include the time tₐ. In this example, anomaly scores of nodes representing metrics y⁽²⁾, y(⁽³⁾, y⁽⁵⁾, and y⁽⁶⁾ are denoted by AS (y⁽²⁾), AS (y⁽³⁾), AS (y⁽⁵⁾), and AS (y⁽⁶⁾), respectively, and are greater than corresponding thresholds, which indicates the metrics y⁽²⁾, y⁽³⁾, y⁽⁵⁾, and y⁽⁶⁾ exhibit anomalous behavior in the time interval [t_{b}, tₑ] 2618. Anomaly scores for the remaining metrics y⁽¹⁾, y⁽⁴⁾, and y⁽⁷⁾ are less than corresponding threshold, which indicates the metrics y⁽¹⁾, y⁽⁴⁾, and y⁽⁷⁾ do not exhibit anomalous behavior in the time interval [t_{b}, tₑ] 2618. Correlation coefficients are also computed for each edge of the dependency graph 2600. Edges connect the metrics y⁽²⁾, y⁽³⁾, y⁽⁵⁾, and y₍₆₎ and have correlations greater than a correlation threshold, which indicates the anomalous behavior exhibited by the metrics y⁽²⁾, y⁽³⁾ , y⁽⁵⁾, and y⁽⁶⁾ may be connected. For example, metric y⁽⁵⁾ exhibits anomalous behavior and anomalous behaving metrics y⁽²⁾ and depend on the metric y⁽⁵⁾, which increases the likelihood that the metric y⁽⁵⁾ is the source of the problem originally exhibited at the KPI y⁽²⁾.

Changes events in the metrics y⁽¹⁾, y⁽²⁾, y⁽³⁾, y⁽⁵⁾, y⁽⁶⁾ and y⁽⁷⁾ may be detected by partitioning the time interval [t_{b}, tₑ] 2618 into subintervals and computing KL-divergence for each metric in each subinterval with respect to corresponding metrics generated in a historical time interval as described above with reference to FIG. 25. FIG. 26C shows example KL-divergence values computed just for the metrics y⁽²⁾, y⁽³⁾, y⁽⁵⁾, and y⁽⁶⁾. The time interval [t_{b}, tₑ] 2618 has been partitioned into four subintervals v(1), v(2), v(3), and v(4). The KL-divergence values of the metrics are denoted by D_{KL}(P∥Q)₍ᵥ₎⁽ⁱ⁾, where superscript (i) corresponds to the metric and subscript (v) corresponds to the subinterval of the time interval [t_{b}, tₑ] 2618. In this example. the KL-divergence values of the metrics y⁽²⁾, y⁽³⁾, y⁽⁵⁾, and y⁽⁶⁾ are greater than corresponding divergence thresholds for the subintervals I(3) and I(4). However, only the metric y⁽⁵⁾ has a KL-divergence value 2624 greater than the divergence threshold for an earlier subinterval I(2). In this example, the metric y⁽⁵⁾ is most likely the root cause of the problem because metric y⁽⁵⁾ exhibits anomalous behavior that is correlated with anomalous behavior exhibited by other metrics y⁽²⁾, y⁽³⁾, and y⁽⁶⁾ that depend on the metric y⁽⁵⁾ and the metric y⁽⁵⁾ exhibits a change event earlier than the metrics y⁽²⁾, y(⁽³⁾, and y⁽⁶⁾.

The metrics of a dependency graph are assigned ranks that correspond to how likely the metric is to the root cause of a problem in a network. A rank for a metric may be determined as a function of a corresponding anomaly score, correlation coefficients with other metrics, and the KL-divergence value. For example, the rank of a metric may be determined as follows:

$$R ( i ) = {w}_{1} AS ( i ) + {w}_{2} {\sum }_{j = 1}^{J} corr ( i , j ) + {w}_{3} {\sum }_{ν = 1}^{V} {{D}_{K L} ( P ‖ Q )}_{( v )}^{( i )} \qquad ( 8 )$$

where

AS(i) is the anomaly score of the metric y⁽ⁱ⁾;

corr(i,j) is the correlation coefficient for the metrics y⁽ⁱ⁾ and y^{(j)} connected by an edge of the dependency graph;

V is the number of subintervals of [t_{b}, tₑ]; and

w₁, w₂, and w₃ are weights.

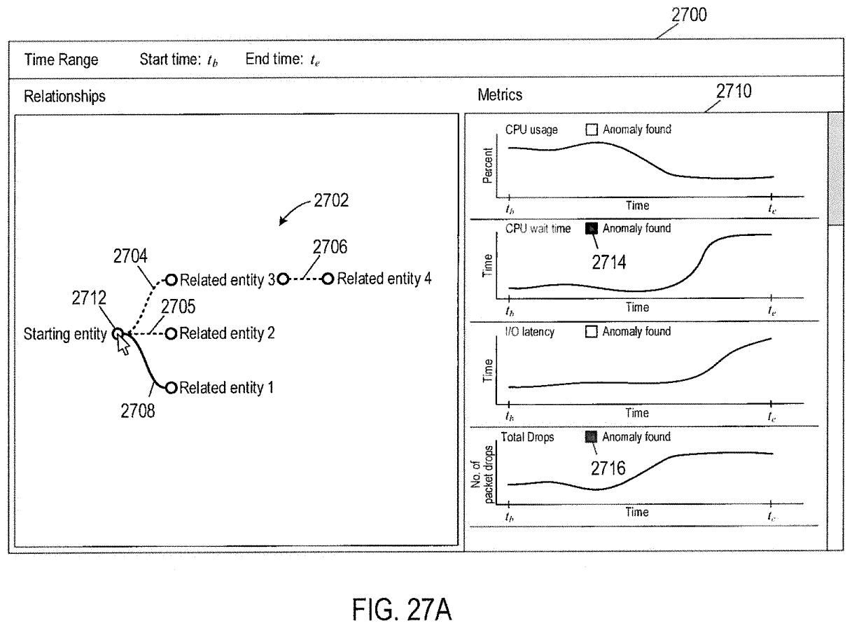

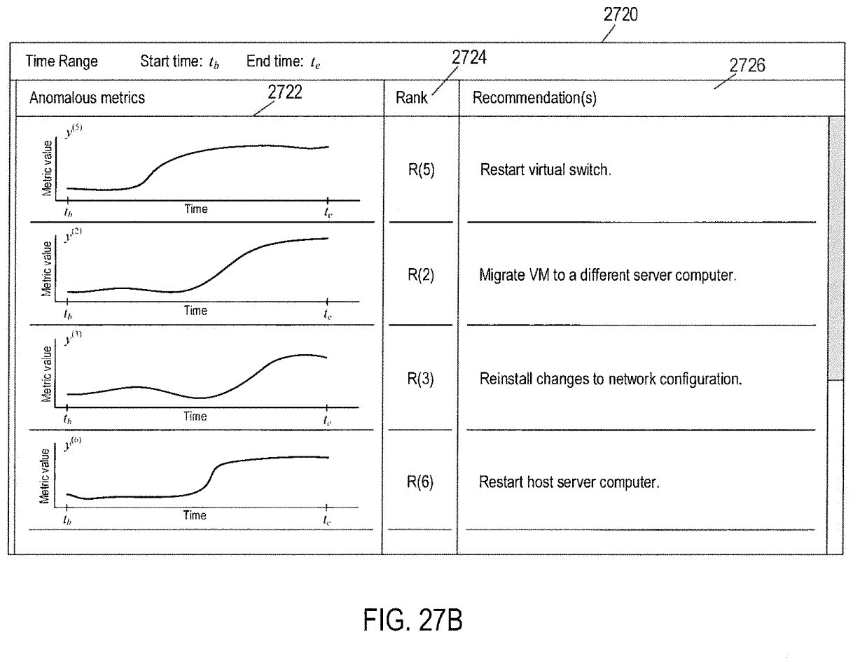

The entities exhibiting anomalous behaving metrics, rank of each metric, and recommendations for correcting the anomalous behaving metric may be displayed in a GUI of a system administrator, developer of the application having problems, or the application owner. FIG. 27A shows an example GUI 2700 that displays example entities of the dependency graph 2600 in an entity graph 2702. The edges of the entity graph 2702 are displayed with different patterns, or colors. to signify anomalous behavior affecting the network connections between the entities. For example, dashed edges 2704-2706 indicate that metrics of connected entities exhibit anomalous behavior and are correlated. Solid edge 2708 indicates that metrics of entities connected by edges in the dependency graph are not correlated. A user may view the metrics associated with each entity in the entity graph in a separate metric panel 2710. For example, when a user selects the starting entity 2712 in the entity graph 2702, the metrics associate with the starting entity are displayed in the metric panel 2710. In this example, entities that exhibit anomalous behavior are identified with shaded “anomaly found” boxes, such as shaded anomaly found boxes 2714 and 2716 for the starting entity.

FIG. 2713 shows an example GUI 2720 that displays the example anomalous metrics y⁽²⁾, y⁽³⁾, y⁽⁵⁾, and y⁽⁶⁾ described above with reference to FIGS. 26A-26C, corresponding ranks, and recommendations for addressing the associated problems. The anomalous metrics are listed in rank order from highest rank to lowest rank in column 2722. Column 2724 list the rank associated with each metric. Column 2726 list the associated recommendations for remedying the corresponding problem. Recommendations may also be listed based on combinations of anomalous behaving metrics. For example, the combination of metrics y⁽²⁾, y⁽³⁾, and y⁽⁵⁾ exhibiting anomalous behavior over the same time interval and dependent on one another as shown in FIG. 26B may be an indication that a switch port has failed and the switch needs to be restarted or replaced. A user may select one or more of remedial measures to correct the anomalous behavior exhibited by the network. For example, a user may click on one of the remedial measures listed, which initiates computational operations that correct the anomalous behavior or provides a user with instructions for correcting the anomalous behavior.

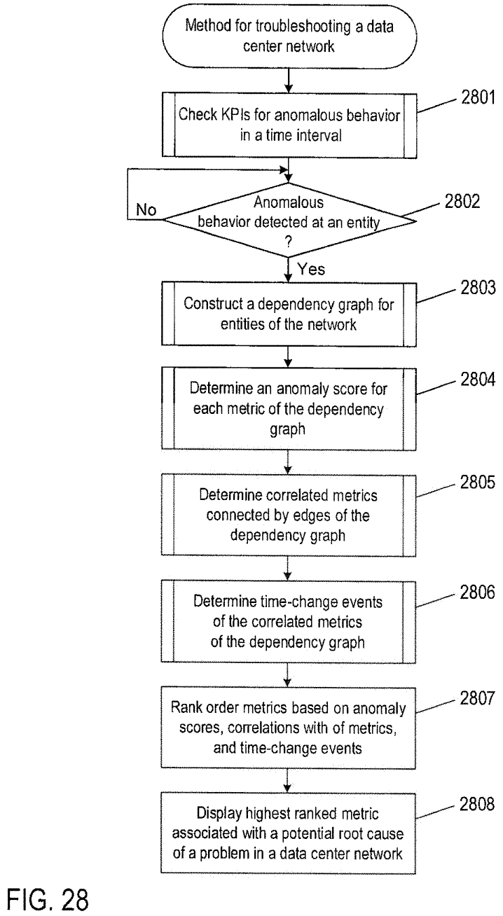

The methods described below with reference to FIGS. 28-33 are stored in one or more data-storage devices as machine-readable instructions and are executed by one or more processors of the computer system shown in FIG. 1.

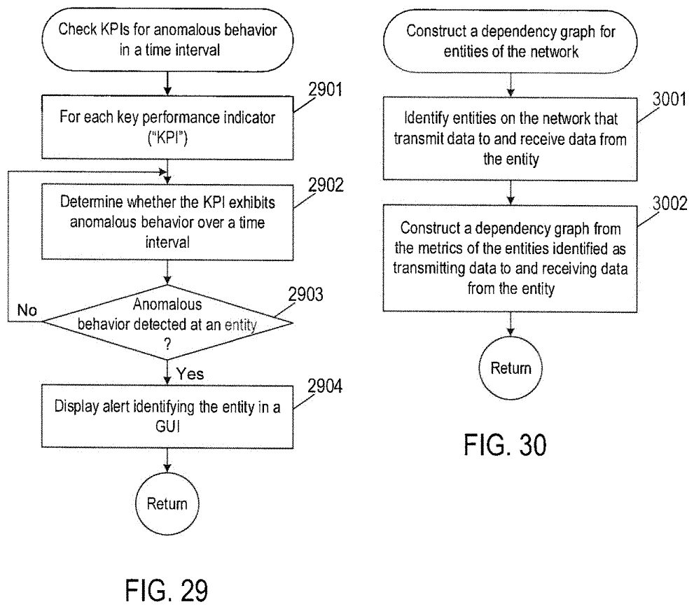

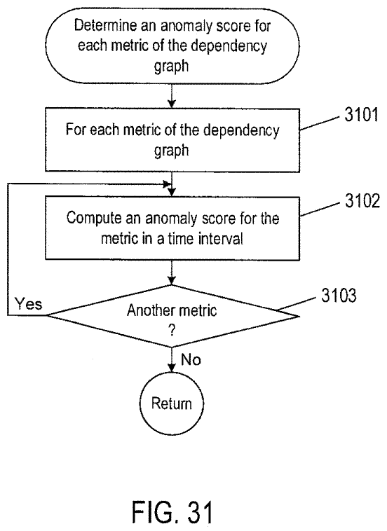

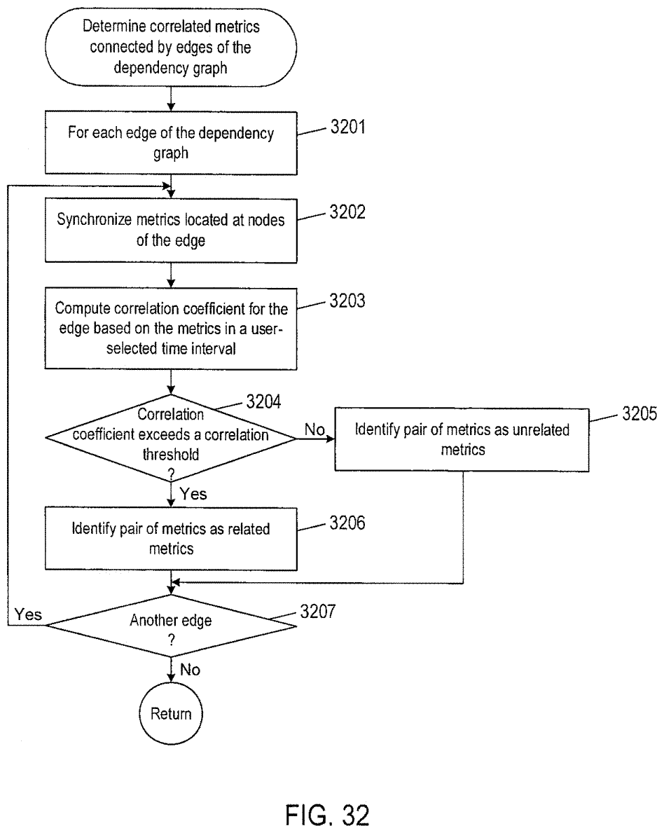

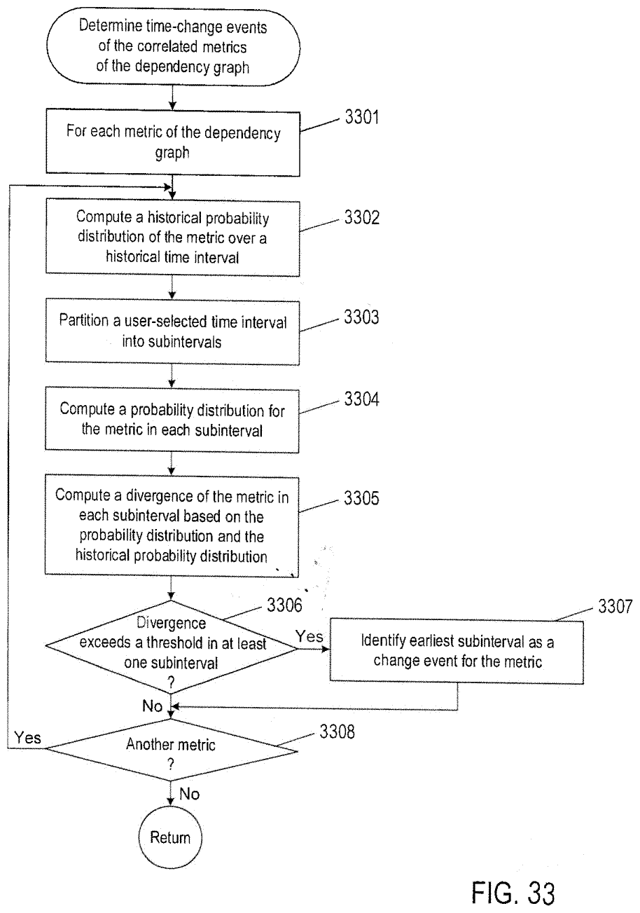

FIG. 28 is a flow diagram of a method for troubleshooting a data center network. In block 2801, a “check KPIs for anomalous behavior in a time interval” procedure is performed. An example implementation of the “check KPIs for anomalous behavior in a time interval” procedure is described below with reference to FIG. 29. In decision block 2802, when anomalous behavior is detected in a KPI of an entity of the network, control flows to block 2803. In block 2803, a “construct a dependency graph for entities of the network” procedure is performed. An example implementation of the “construct a dependency graph for entities of the network” procedure is described below with reference to FIG. 29. In block 2804, a “determine an anomaly score for each metric of the dependency graph” procedure is performed. An example implementation of the “determine an anomaly score for each metric of the dependency graph” procedure is described below with reference to FIG. 31. In block 2805, a “determine correlated metrics connected by edges of the dependency graph” procedure is performed. An example implementation of the “determine correlated metrics connected by edges of the dependency graph” procedure is described below with reference to FIG. 32. In block 2806, a “determine time-change events of the correlated metrics of the dependency graph” procedure is performed. An example implementation of the “determine time-change events of the correlated metrics of the dependency graph” procedure is described below with reference to FIG. 33. In block 2807, the metrics of the dependency graph are rank ordered based on the corresponding anomaly scores. correlations with other metrics. and time-change events. In block 2808, highest ranked metrics associated with a potential root cause of a problem in the data center network are displayed in a graphical user interface of computer console. The graphical user interface may also be used to display remedial measures that correspond to the highest ranked potential root causes of the network problem. A user may select one of the remedial measures. Methods and systems execute the selected remedial measure to correct the anomalous behavior exhibited the network.

FIG. 29 is a flow diagram illustrating an example implementation of the “check KPIs for anomalous behavior in a time interval” procedure performed in block 2801. A loop beginning with block 2901 repeats the operation represented by block 2902 for each KPI. In block 2902, techniques described above with reference to Equations (2a)-(2b) and (3a)-(3c) and corresponding FIGS. 17 and 18. In decision block 2903, when anomalous behavior is detected in an a KPI of an entity, control flows to block 2904. In block 2904, an alert identifying the entity exhibiting anomalous behavior is displayed in a graphical user interface as described above with reference to FIG. 19.

FIG. 30 is a flow diagram illustrating an example implementation of the “construct a dependency graph for entities of the network” procedure performed in block 2803. In block 3002, entities on the network that transmit data to and receive data from the entity identify for troubleshooting are identified as described above with reference to FIGS. 21A-21B. In decision block 3003, a dependency graph is constructed from the metrics of the entities identified as transmitting data to and receiving data from the entity is constructed as described above with reference to FIGS. 21A-21B.

FIG. 31 is a flow diagram illustrating an example implementation of the “determine an anomaly score for each metric of the dependency graph” procedure performed in block 2804. A loop beginning with block 3101 repeats the operation represented by block 3102 for each metric of the dependency graph. In block 3102. an anomaly score is computed for each metric of the dependency graph as described in Equations (2a)-(2b), (3a)-(3c) or (4a)-(4b). In decision block 3103, the operation represented by block 3102 until an anomaly score has been computed for each metric of the dependency graph.

FIG. 32 is a flow diagram illustrating an example implementation of the “determine correlated metrics connected by edges of the dependency graph” procedure performed in block 2805. A loop beginning with block 3201 repeats the operations represented by blocks 3202-3206 for each edge of the dependency graph. In block 3202, the metric located at nodes of the edge are synchronized as described above with reference to FIGS. 24A-24C. In block 3203, a correlation coefficient is computed for the edge based on the metrics in a user-selected time interval. In decision block 3204, when the correlation coefficient exceeds a correlation threshold, control flows to block 3206. Otherwise, control flows to block 3205. In block 3205, the metrics associated with edge are identified as unrelated. In block 3206, the metrics associated with edge are identified as related. In decision block 3207, blocks 3202-3206 are repeated for each edge of the dependency graph.

FIG. 33 is a flow diagram illustrating an example implementation of the “determine time-change events of the correlated metrics of the dependency graph” procedure performed in block 2806. A loop beginning with block 3301 repeats the operations represented by blocks 3302-3307 for each metric of the dependency graph. In block 3302, a historical probability distribution is computed as described above with reference to Equation (7a). In block 3303 a user-selected time interval is partitioned in subintervals as described above with reference to FIG. 26C. In block 3304, a probability distribution is computed for the metric in subinterval as described above with reference to Equation (7b) and FIG. 26C. In block 3305, a divergence is computed as described with reference to Equation (7c) or (7d) and FIG. 26C. In decision block 3306, when the divergence exceeds a threshold in at least one of the subintervals, control flows to block 3307. In block 3307, the earliest subinterval as containing a change event for the metric. In decision block 3308, blocks 3308 are repeated for each metric of the dependency graph.

It is appreciated that the previous description of the disclosed embodiments is provided to enable any person skilled in the art to make or use the present disclosure. Various modifications to these embodiments will be apparent to those skilled in the art. and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method stored in one or more data-storage devices and executed using one or more processors of a computer system for troubleshooting a network of a data center, the method comprising:
constructing a dependency graph of an entity of the network exhibiting anomalous behavior, the dependency graph having nodes that represent metrics of entities that communicate with the entity over the network and metrics of entities that provide or consume network and storage resources used by the entity and edges that represent connections between metrics:
determining an anomaly score for each metric of the dependency graph;
determining correlated metrics connected by the edges of the dependency graph;
determining time-change events of the metrics of the dependency graph;
rank ordering each metric of the dependency graph based on the anomaly scores, correlations with other metrics, and the time-change events; and
executing a remedial measure to correct anomalous behavior associated with a highest ranked metric.

2. The method of claim I wherein constructing the dependency graph comprises:
for each key performance indicator (“KPI”) of entities that transmit and receive data over the network
determining whether the KPI exhibits anomalous behavior, and
in response to detecting anomalous behavior of the KPI, triggering an alert that is displayed in a GUI and identifies an entity associated with the KPI;
identifying entities that transmit data to and receive data from the entity over the network and provide or consume network. storage, or resources of the entity; and
constructing the dependency graph based on metrics of the entity and metrics of the entities that transmit data to and receive data from the entity over the network.

3. The method of claim 1 wherein determining the anomaly score for each metric of the dependency graph comprises:
for each metric of the dependency graph
computing a long-term mean for the metric over a user-selected time interval,
computing a short-term mean for the metric over a most recent subinterval of the selected time interval, and
computing an anomaly score as an absolute different between the long-term mean and the short-term mean.

4. The method of claim 1 wherein determining the anomaly score for each metric of the dependency graph comprises:
for each metric of the dependency graph
computing a mean for the metric over a user-selected time interval,
computing a standard deviation for the metric over the user-selected time interval, and
computing an anomaly score for metric values that violate an upper or lower bound that are based on the mean and standard deviation.

5. The method of claim 1 wherein determining the anomaly score fir each metric of the dependency graph comprises determining one of a mean absolute deviation over a user-selected time interval and a median absolute deviation over the user-selected time interval.

6. The method of claim 1 wherein determining the correlated metrics connected by edges of the dependency graph comprises:
for each edge of the dependency graph
synchronizing the pair of metrics located at nodes of the edge,
computing a correlation coefficient for the edge based on the pair of metric in a user-selected time interval, and
when absolute value of correlation coefficient exceeds a correlation threshold, identifying the pair of metrics as related metric. otherwise identifying the pair of metrics as unrelated.

7. The method of claim 1 wherein determining the time-change events of the correlated metrics of the dependency graph comprises:
for each metric of the dependency graph
computing a historical probability distribution of the metric over a historical time interval.
partitioning a user-selected time interval into subintervals.
computing a probability distribution for metric in each subinterval,
computing a divergence for the metric in each subinterval based on the probability distribution for the metric in each subinterval and the historical probability distribution. and
when a divergence exceeds a threshold in at least one subinterval, identifying an earliest subinterval as a change event for the metric.

8. The method of claim 1 further comprising:
determining remedial measures for the highest ranked metrics;
displaying the remedial measures in the graphical user interface: and
executing the remedial measure selected by the user to correct the anomalous behavior.

9. A computer system for troubleshooting a data center network. the system comprising:
one or more processors;
one or more data-storage devices: and
machine-readable instructions stored in the one or more data-storage devices that when executed using the one or more processors controls the system to execute operations comprising:
constructing a dependency graph in response 4) a user selecting in a graphical user interface an entity of the network, the dependency graph having nodes that represent metrics of entities that communicate with the entity over the network and metrics of entities that provide or consume network and storage resources used by the entity and edges that represent connections between metrics;
determining an anomaly score for each metric of the dependency graph;
determining correlated metrics connected by the edges of the dependency graph;
determining time-change events of the metrics of the dependency graph;
rank ordering each metric of the dependency graph based on the anomaly scores, correlations with other metrics, and the time-change events; and
displaying in the graphical user interface highest ranked metrics associated with a potential root cause of anomalous behavior exhibited by the entity and corresponding remedial measures for correcting the anomalous behavior associated with the highest ranked metrics.

10. The computer system of claim 9 wherein constructing the dependency graph comprises:
for each key performance indicator (“KPI”) of entities that transmit and receive data over the network
determining whether the KPI exhibits anomalous behavior, and
in response to detecting anomalous behavior of the KPI, triggering an alert that is displayed in a GUI and identifies an entity associated with the KPI:
identifying entities that transmit data to and receive data from the entity over the network and provide or consume network, storage, or resources of the entity: and
constructing the dependency graph based on metrics of the entity and metrics of the entities that transmit data to and receive data from the entity over the network.

11. The computer system of claim 9 wherein determining the anomaly score for each metric of the dependency graph comprises:
for each metric of the dependency graph
computing a long-term mean for the metric over a user-selected time interval,
computing a short-term mean for the metric over a most recent subinterval of the selected time interval, and
computing an anomaly score as an absolute different between the long-term mean and the short-term mean.

12. The computer system of claim 9 wherein determining the anomaly score for each metric of the dependency graph comprises:
for each metric of the dependency graph
computing a mean for the metric over a user-selected time interval,
computing a standard deviation for the metric over the user-selected time interval, and
computing an anomaly score for metric values that violate an upper or lower bound that are based on the mean and standard deviation.

13. The computer system of claim 9 wherein determining the anomaly score for each metric of the dependency graph comprises determining one of a mean absolute deviation over a user-selected time interval and a median absolute deviation over the user-selected time interval.

14. The computer system of claim 9 wherein determining the correlated metrics connected by edges of the dependency graph comprises:
for each edge of the dependency graph
synchronizing the pair of metrics located at nodes of the edge,
computing a correlation coefficient for the edge based on the pair of metric in a user-selected time interval, and
when absolute value of correlation coefficient exceeds a correlation threshold, identifying the pair of metrics as related metric, otherwise identifying the pair of metrics as unrelated.

15. The computer system of claim 9 wherein determining the time-change events of the correlated metrics of the dependency graph comprises:
for each metric of the dependency graph
computing a historical probability distribution of the metric over a historical time interval,
partitioning a user-selected time interval into subintervals.
computing a probability distribution for metric in each subinterval,
computing a divergence for the metric in each subinterval based on the probability distribution for the metric in each subinterval and the historical probability distribution, and
when a divergence exceeds a threshold in at least one subinterval, identifying an earliest subinterval as a change event for the metric.

16. The computer system of claim 9 further comprising:
determining remedial measures for the highest ranked metrics^{., and}
executing remedial measure selected by a user to correct the anomalous behavior.

17. A non-transitory computer-readable medium encoded with machine-readable instructions that implement a method carried out by one or more processors of a computer system to perform operations comprising:
constructing a dependency graph in response to an entity of the network exhibiting anomalous behavior, the dependency graph having nodes that represent metrics of entities that communicate with the entity over the network and metrics of entities that provide or consume network and storage resources used by the entity and edges that represent connections between metrics;
determining an anomaly score for each metric of the dependency graph:
determining correlated metrics connected by the edges of the dependency graph;
determining time-change events of the metrics of the dependency graph;
rank ordering each metric of the dependency graph based on the anomaly scores, correlations with other metrics, and the time-change events; and
displaying in a graphical user interface highest ranked metrics associated with a potential root cause of the anomalous behavior.

18. The medium of claim 17 wherein constructing the dependency graph comprises:
for each key performance indicator (“KPI”) of entities that transmit and receive data over the network
determining whether the KPI exhibits anomalous behavior, and
in response to detecting anomalous behavior of the KPI, triggering an alert that is displayed in a GUI and identifies an entity associated with the KPI;
identifying entities that transmit data to and receive data from the entity over the network and entities that provide or consume network and storage resources used by the entity; and
constructing the dependency graph based on metrics of the entity and metrics of the ent that transmit data to and receive data from the entity over the network.

19. The medium of claim 17 wherein determining the anomaly score for each metric of the dependency graph comprises:
for each metric of the dependency graph
computing a long-term mean for the metric over a user-selected time interval.
computing a short-term mean for the metric over a most recent subinterval of the selected time interval, and
computing an anomaly score as an absolute different between the long-term mean and the short-term mean.

20. The medium of claim 17 wherein determining the anomaly score for each metric of the dependency graph comprises:
for each metric of the dependency graph
computing a mean for the metric over a user-selected time interval,
computing a standard deviation for the metric over the user-selected time interval, and
computing an anomaly score for metric values that violate an upper hound or lower bound that are based on the mean and standard deviation.

21. The medium of claim 17 wherein determining the anomaly score for each metric of the dependency graph comprises determining one of a mean absolute deviation over a user-selected time interval and a median absolute deviation over the user-selected time interval.

22. The medium of claim 17 wherein determining the correlated metrics connected by edges of the dependency graph comprises:
for each edge of the dependency graph
synchronizing the pair of metrics located at nodes of the edge.
computing a correlation coefficient for the edge based on the pair of metric in a user-elected time interval, and
when absolute value of correlation coefficient exceeds a correlation threshold, identifying the pair of metrics as related metric, otherwise identifying the pair of metrics as unrelated.

23. The medium of claim 17 wherein determining the time-change events of the correlated metrics of the dependency graph comprises:
for each metric of the dependency graph
computing a historical probability distribution of the metric over a historical time interval,
partitioning a user-selected time interval into subintervals.
computing a probability distribution for the metric in each subinterval.
computing a divergence for the metric in each subinterval based on the probability distribution for the metric in each subinterval and the historical probability distribution, and
when a divergence exceeds a threshold in at least one subinterval, identifying an earliest subinterval as a change event for the metric.

24. The medium of claim 17 further comprising:
determining remedial measures for the highest ranked metrics:
displaying the remedial measures in the graphical user interface: and
executing the remedial measure selected by the user to correct the anomalous behavior.
